(19) United States
(12) Patent Application Publication
(10) Pub. No.: US 2017/0140362 A1
(43) Pub. Date: May 18, 2017

(54) INFORMATION PROCESSING DEVICE, INFORMATION PROCESSING METHOD, AND PROGRAM

(71) Applicant: NEC Corporation, Minato-ku, Tokyo (JP)

(72) Inventors: Hiroyasu YAMAGUCHI, Tokyo (JP); Motoko MIURA, Tokyo (JP); Takuro SAKUMA, Tokyo (JP)

(73) Assignee: NEC Corporation, Minato-ku, Tokyo (JP)

(21) Appl. No.: 15/322,234

(22) PCT Filed: Jun. 29, 2015
(86) PCT No.: PCT/JP2015/068633

§ 371 Date: Dec. 27, 2016

(30) Foreign Application Priority Data
Jul. 1, 2014 (JP) 2014-136164

(51) Int. Cl. G06Q 20/20; G06Q 30/02

(52) U.S. Cl. CPC G06Q 20/208; G06Q 30/0238

(57) ABSTRACT

An information processing device (10) includes a commodity detection unit (110) that detects a commodity information symbol, a service detection unit (120) that detects a service information symbol, and an association unit (130) that associates with each other commodity information and service information, which are obtained using the detected commodity information symbol and service information symbol in a case where after the commodity information symbol is detected and before a first predetermined time period elapses, the service information symbol is detected, or associates with each other commodity information and service information, which are obtained using the detected commodity information symbol and service information symbol in a case where after the service information symbol is detected and before a second predetermined time period longer than the first predetermined time period elapses, the commodity information symbol is detected.

### TECHNICAL FIELD

The present invention relates to a technique for associating commodity information and service information with each other.

### BACKGROUND ART

Commodities displayed in a store include a commodity to which a seal indicating price reduction information of the commodity is attached together with a bar code for identifying the commodity. An operator of a point of sale (POS) terminal makes the POS terminal read a bar code given to a commodity and then views a price reduction seal attached to the commodity, thereby performing a price reduction operation.

Patent Document 1 mentioned below proposes a POS terminal that performs checkout of a commodity to which a bar code indicating commodity information and a bar code indicating price reduction information are attached. The POS terminal further reads not only the bar code indicating commodity information but also the bar code indicating price reduction information to thereby perform the price reduction of a target commodity.

### RELATED DOCUMENT

### Patent Document

[Patent Document 1] JP-A-2003-85657

### SUMMARY OF THE INVENTION

### Technical Problem

In the proposed method described above, the POS terminal detects a bar code (commodity information symbol) indicating commodity information and a bar code (service information symbol) indicating price reduction information. However, in such a POS terminal, the detected order of the commodity information symbol and the service information symbol may not be fixed. There is a possibility that a commodity information symbol is first detected and a service information symbol is then detected in a certain commodity, and a service information symbol is first detected and a commodity information symbol is then detected in the next commodity. Such cases are caused by an operator's different ways of holding a commodity over a scanning apparatus of a POS terminal, the different arrangement of symbols in commodities, and the like. In addition, a commodity having service information attached thereto and a commodity having no service information attached thereto are present, and thus it is desired that commodity information of a target commodity and service information attached to the commodity are correctly associated with each other in a POS terminal.

The invention provides a technique for correctly associating commodity information of a commodity and service information attached to the commodity with each other.

### Solution to Problem

In aspects of the invention, the following configurations are adopted in order to solve the above-described problems.

A first aspect relates to an information processing device. The information processing device according to the first aspect includes a commodity detection unit that detects a commodity information symbol, a service detection unit that detects a service information symbol, and an association unit that associates with each other commodity information and service information, which are obtained using detected commodity information symbol and service information symbol in a case where after the commodity information symbol is detected and before a first predetermined time period elapses, the service information symbol is detected and in a case where after the service information symbol is detected and before a second predetermined time period longer than the first predetermined time period elapses, the commodity information symbol is detected.

A second aspect relates to an information processing method which is performed by at least one computer. The information processing method according to the second aspect includes detecting a commodity information symbol, detecting a service information symbol, and associating with each other commodity information and service information, which are obtained using detected commodity information symbol and service information symbol in a case where after the commodity information symbol is detected and before a first predetermined time period elapses, the service information symbol is detected and in a case where after the service information symbol is detected and before a second predetermined time period longer than the first predetermined time period elapses, the commodity information symbol is detected.

Meanwhile, another aspect of the invention relates to a program causing at least one computer to perform the method of the second aspect, and relates to a computer readable recording medium having the program recorded thereon. The recording medium includes a non-transitory tangible medium.

### Advantageous Effects of Invention

According to the invention, it is possible to correctly associate commodity information of a commodity and service information attached to the commodity with each other.

### BRIEF DESCRIPTION OF THE DRAWINGS

The above-described objects, other objects, features and advantages will become more apparent from the preferred exemplary embodiments described below, and the accompanying drawings as follows.

FIG. 1 is a schematic diagram showing a processing configuration of an information processing device in a first exemplary embodiment.

FIG. 2 is a diagram showing an example of information stored in an association storage unit.

FIG. 3 is a diagram showing an example of a screen displayed by a display processing unit on the basis of information of the association storage unit shown in FIG. 2.

FIG. 4 is a schematic diagram showing an example of a hardware configuration of the information processing device in the first exemplary embodiment.

FIG. 5 is a flow chart showing a flow of a process in which the information processing device in the first exemplary embodiment detects a first symbol.

FIG. 6 is a flow chart showing a flow of a process of the information processing device in the first exemplary embodiment in a case where a commodity information symbol is detected as a first symbol in FIG. 5.

FIG. 7 is a flow chart showing a flow of the information processing device in the first exemplary embodiment in a case where a service information symbol is detected as a first symbol in FIG. 5.

FIG. 8 is a diagram showing information stored in the association storage unit and a screen displayed on a display unit.

FIG. 9 is a diagram showing information stored in the association storage unit and a screen displayed on the display unit.

FIG. 10 is a diagram showing information stored in the association storage unit and a screen displayed on the display unit.

FIG. 11 is a diagram showing information stored in the association storage unit and a screen displayed on the display unit.

FIG. 12 is a diagram showing information stored in the association storage unit and a screen displayed on the display unit.

FIG. 13 is a diagram showing information stored in the association storage unit and a screen displayed on the display unit.

FIG. 14 is a diagram showing a predetermined output of an output unit.

FIG. 15 is a diagram showing information stored in the association storage unit and a screen displayed on the display unit.

FIG. 16 is a schematic diagram showing a processing configuration of an information processing device in a second exemplary embodiment.

FIG. 17 is a flowchart showing a flow of a process of the information processing device in the second exemplary embodiment in a case where a commodity information symbol is detected as a first symbol in FIG. 5.

FIG. 18 is a flow chart showing a flow of a process of the information processing device in the second exemplary embodiment in a case where a service information symbol is detected as a first symbol in FIG. 5.

FIG. 19 is a diagram showing an example of a configuration of a POS register device.

FIG. 20 is a diagram showing an example of a configuration of a POS system.

FIG. 21 is a diagram showing a commodity image obtained by capturing one commodity.

### DESCRIPTION OF EXEMPLARY EMBODIMENTS

Hereinafter, exemplary embodiments of the invention will be described. Meanwhile, the following exemplary embodiments are just examples, and the invention is not limited to configurations of the following exemplary embodiments.

### First Exemplary Embodiment

[Processing Configuration]

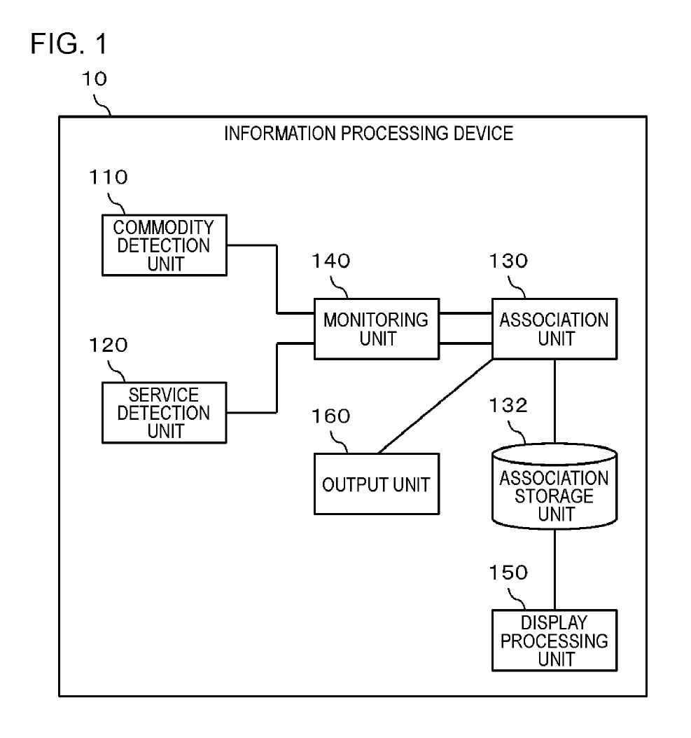

FIG. 1 is a schematic diagram showing a processing configuration of an information processing device in a first exemplary embodiment. As shown in FIG. 1, an information processing device 10 of the present exemplary embodiment includes a commodity detection unit 110, a service detection unit 120, an association unit 130, an association storage unit 132, a monitoring unit 140, a display processing unit 150, and an output unit 160.

The commodity detection unit 110 detects a commodity information symbol from a commodity label or the like. The wording “commodity label” as used herein refers to a member (seal or the like), showing a commodity information symbol, which is attached to a commodity, a packing material of a commodity, or the like, or refers to a region in which a commodity information symbol is printed on a commodity, a packing material of a commodity, or the like. The wording “commodity information symbol” as used herein refers to a form from which commodity information can be acquired, includes a one-dimensional code or a two-dimensional code having a commodity code encoded therein, a character string symbol (character string form) indicating commodity information, and the like. The wording “commodity information” as used herein refers to any information regarding a commodity such as the name, price, or commodity code of a commodity. The wording “commodity code” as used herein refers to commodity identification data, formed of characters, numbers, or signs, which is determined in advance in order to specify each commodity. A price look up (PLU) code (for example, a Japan article number (JAN) code or the like), a Non-PLU code, or the like may be used as the commodity code. In a case where a commodity code is a PLU code, commodity information is acquired with reference to a storage unit (not shown) that stores commodity information on the basis of the detected PLU code. In addition, in a case where a commodity code is a Non-PLU code, commodity information is acquired from the detected Non-PLU code. The wording “character string symbol indicating commodity information” as used herein refers to a symbol from which any commodity information is obtained by analyzing the symbol, and examples thereof include a character string indicating the name or price of a commodity which is written on a packing material of the commodity, a seal attached to a packing material, or the like. However, the character string symbol indicating commodity information is not limited to these examples.

The commodity detection unit 110 analyzes an image obtained by capturing the appearance of a commodity by using, for example, a known image analysis algorithm or the like to thereby detect a commodity information symbol. In addition, the commodity detection unit 110 may also detect a commodity information symbol on the basis of detection results of reflected light of light emitted to a packing material of a commodity, or the like by using a light source and a light receiving element. In a case where a commodity information symbol is a character string symbol, a known character recognition method is used.

The commodity detection unit 110 operates at all times asynchronously with a service detection unit 120 to be described later. However, the commodity detection unit 110 may operate periodically at time intervals shorter than a first predetermined detection time to be described later. Since the commodity detection unit 110 and the service detection unit 120 operate asynchronously with each other, the detected order of a commodity information symbol and a service information symbol is not fixed in the present exemplary embodiment. For example, regarding a commodity in which both a commodity information symbol and a service information symbol are present, a commodity information symbol may be first detected, or a service information symbol may be first detected.

Since the commodity detection unit 110 operates at all times as described above, a commodity information symbol of the same commodity may be repeatedly detected a plurality of times depending on a way of holding a commodity over a reading unit 108 to be described later. Consequently, in a case where the commodity detection unit 110 detects a new commodity information symbol (the present commodity information symbol) after a fixed time (first predetermined detection time) elapses from the detection of the former commodity information symbol, the new commodity information symbol is set as the next commodity information symbol. In other words, in a case where the latter commodity information symbol is detected before a first predetermined detection time elapses after the former commodity information symbol is detected, the commodity detection unit 110 discards the latter commodity information symbol without setting the latter commodity information symbol as the next commodity information symbol. However, in a case where pieces of commodity information indicated by respective commodity information symbols are different from each other even when the latter commodity information symbol is detected before the first predetermined detection time elapses after the former commodity information symbol is detected, the commodity detection unit 110 may set the latter commodity information symbol as the next commodity information symbol. Hereinafter, the wording “detection of a commodity information symbol by the commodity detection unit 110” as used herein will refer to detection of a commodity information symbol of a different commodity among all detections of commodity information symbols which are performed by the commodity detection unit 110 in a case where a description is not particularly given. The wording “first predetermined detection time” as used herein is empirically or theoretically calculated on the basis of an operator's actual commodity checkout operation such as a way of holding a commodity over the reading unit 108 to be described later, and is set in the commodity detection unit 110 in advance. In addition, the “first predetermined detection time” may be a different time for each operator. In this case, a different “first predetermined detection time” is set in the information processing device 10 (POS terminal or the like), and a first predetermined detection time is changed over on the basis of an operator's selection input, an input of information (for example, employee code or the like) for identifying an operator taking charge of processing, or the like. For example, each of the first predetermined detection times can be derived using an average value, an intermediate value, and the like from learning results of an actual processing time of each operator which are obtained by a learning unit (not shown) of the information processing device 10. Thereby, it is possible to optimize a first predetermined detection time for each operator.

The service detection unit 120 detects a service information symbol from a service label. The wording “service label” as used herein refers to a member that displays a service information symbol attached to a commodity, a packing material of a commodity, or the like. The wording “service information symbol” as used herein refers to a form from which service information can be acquired, includes a one-dimensional code or a two-dimensional code having a service code encoded therein, a character string symbol (character string form) indicating service information, and the like. The wording “service information” as used herein refers to information indicating contents of all services given to commodities. The service information includes price reduction information such as “20 yen price discount”, discount information such as “30% discount”, extra point information such as “five-times point providing”, a service code specifying each service, and the like. The wording “service code” as used herein refers to service identification data, formed of characters, numbers, signs, and the like, which is determined in advance in order to specify each service. The corresponding service information is acquired with reference to a storage unit (not shown) that stores information regarding each service on the basis of such a service code. The wording “character string symbol indicating service information” refers to a symbol from which any service information is obtained by the analysis thereof, and examples thereof include a character string, indicating a price reduction amount or a discount rate, which is written on a packing material of a commodity, a seal attached to a packing material of a commodity, or the like. Meanwhile, a character string symbol indicating service information is not limited to these examples.

The service detection unit 120 analyzes an image obtained by capturing the appearance of a commodity by using, for example, a known image analysis algorithm or the like to thereby detect a service information symbol. In addition, the service detection unit 120 may also detect a service information symbol on the basis of detection results of reflected light of light emitted to a packing material of a commodity, or the like by using a light source and a light receiving element. In a case where a service information symbol is a character string symbol, a known character recognition method is used.

In addition, as described above, the service detection unit 120 operates at all times asynchronously with the commodity detection unit 110. However, the service detection unit 120 may operate periodically at time intervals shorter than a second predetermined detection time to be described later.

The service detection unit 120 may repeatedly detect a service information symbol of the same commodity a plurality of times, similar to the commodity detection unit 110. Consequently, in a case where the service detection unit 120 detects a new service information symbol (the present service information symbol) after a fixed time (second predetermined detection time) elapses from the detection of the former service information symbol, the new service information symbol is set as the next service information symbol. In other words, in a case where the latter service information symbol is detected before a second predetermined detection time elapses after the former service information symbol is detected, the service detection unit 120 discards the latter service information symbol without setting the latter service information symbol as the next service information symbol. However, in a case where pieces of service information indicated by respective service information symbols are different from each other even when the latter service information symbol is detected before the second predetermined detection time elapses after the former service information symbol is detected, the service detection unit 120 may set the latter service information symbol as the next service information symbol. Hereinafter, the wording “detection of a service information symbol by the service detection unit 120” as used herein will refer to detection of a service information symbol of a different commodity among all detections of service information symbols which are performed by the service detection unit 120 in a case where a description is not particularly given. The wording “second predetermined detection time” as used herein is empirically or theoretically calculated on the basis of an operator's actual commodity checkout operation such as a way of holding a commodity over the reading unit 108 to be described later, and is set in the service detection unit 120 in advance, similar to a case of the commodity detection unit 110.

In a case where a service information symbol is detected before a first predetermined reference time period (first predetermined time period), which is a standard for determining whether to perform association, elapses after a commodity information symbol is detected, the association unit 130 associates commodity information and service information, which are obtained using the respective detected symbols, with each other. In addition, in a case where a commodity information symbol is detected before a second predetermined reference time period (second predetermined time period) longer than the first predetermined reference time period elapses after a service information symbol is detected, the association unit 130 associates commodity information and service information, which are obtained using the respective detected symbols, with each other. In addition, in a case where another symbol is detected after the first predetermined reference time period elapses from the detection of a commodity information symbol or after the second predetermined reference time period elapses from the detection of a service information symbol, the association unit 130 does not associate commodity information and service information, which are obtained using the respective symbols, with each other. In other words, the commodity information and the service information, which are not associated with each other here, are determined to be pieces of information regarding different commodities. The association unit 130 of the present exemplary embodiment determines whether or not another symbol has been detected before the first predetermined reference time period or the second predetermined reference time period elapses, on the basis of the monitoring results of an elapsed time which is performed by the monitoring unit 140 to be described later. In addition, the association unit 130 of the present exemplary embodiment stores commodity information and service information, which are obtained using the symbols detected by the commodity detection unit 110 or the service detection unit 120, in the association storage unit 132 on the basis of a correspondence relationship between the pieces of information.

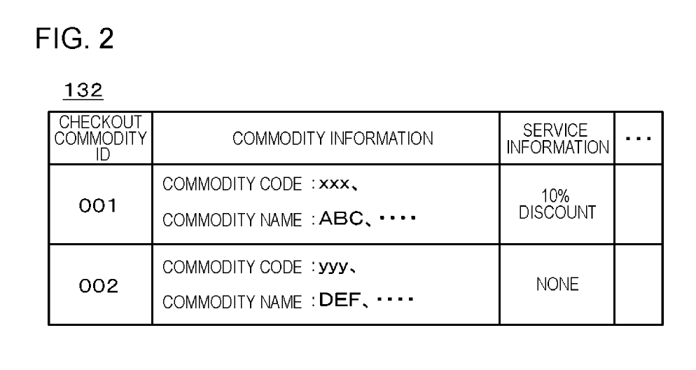

The association storage unit 132 stores commodity information and service information, which are obtained using the respective symbols in a manner capable of determining a correspondence relationship therebetween. FIG. 2 is a diagram showing an example of information stored in the association storage unit 132. A “checkout commodity ID” indicates the registration order of commodities registered as object to be checked out by an operator, that is, the order in which an operator holds a commodity over the reading unit 108 to be described later. In the example of FIG. 2, commodity information and service information regarding the same commodity are associated with each other by the “checkout commodity ID”. In detail, a first line of FIG. 2 shows an example of pieces of information stored as results of association of commodity information and service information which is performed by the association unit 130. A second line of FIG. 2 shows an example of pieces of information stored as results of determination that there is no service information to be associated with commodity information by the association unit 130. Meanwhile, FIG. 2 is just an example, and information stored in the association storage unit 132 is not limited to the example of FIG. 2. In addition, the association storage unit 132 may be included in the information processing device 10, or may be included in another device which is communicably connected to the information processing device 10.

The monitoring unit 140 monitors whether the first predetermined reference time period has elapsed after a commodity information symbol is detected or whether the second predetermined reference time period has elapsed after a service information symbol is detected. Specifically, either (first symbol) a commodity information symbol or a service information symbol which is a target for association in a state where no symbol is detected is first detected, and the monitoring unit 140 starts a process of monitoring a time elapsed after the detection with respect to the first symbol. The monitoring unit 140 terminates the monitoring process with respect to the first symbol in accordance with the detection of another symbol (second symbol) within a predetermined time period (first or second predetermined reference time period) depending on the type of first symbol or in accordance with the elapse of a predetermined time period depending on the type of first symbol. In a case where a new first symbol is detected after the monitoring process is terminated, the monitoring unit 140 starts a monitoring process with respect to the new first symbol. The monitoring unit 140 repeats a flow of this process. In addition, in a case where the first predetermined reference time period or the second predetermined reference time period elapses, the monitoring unit 140 notifies the association unit 130 of the elapse of the time. Thereby, the association unit 130 can determine that a service information symbol has been detected within the first predetermined reference time period from the detection of a commodity information symbol and that a commodity information symbol has been detected within the second predetermined reference time period from the detection of a service information symbol.

Here, the monitoring unit 140 may monitor a time elapsed after the detection of each symbol as follows. For example, in a case where each symbol is detected by the commodity detection unit 110 or the service detection unit 120, the monitoring unit 140 starts up a timer for determining a time elapsed from the detection of each symbol. In addition, for example, the monitoring unit 140 may monitor a time elapsed from the detection of each symbol by holding a time at which each symbol is detected by the commodity detection unit 110 or the service detection unit 120 and comparing the held time and the present time with each other. However, a method for monitoring a time elapsed from the detection of each symbol is not limited to these examples.

In addition, information indicating the first predetermined reference time period and the second predetermined reference time period is stored in advance in, for example, a storage unit not shown in the drawing, or the like. The monitoring unit 140 may determine whether the first predetermined reference time period or the second predetermined reference time period has elapsed from the detection of each symbol by using the first predetermined reference time period or the second predetermined reference time period which is stored in the storage unit. In addition, the invention is not limited thereto, and either the first predetermined reference time period or the second predetermined reference time period may be stored in the above-mentioned storage unit as a reference time period. In this case, the other reference time period out of the first predetermined reference time period and the second predetermined reference time period is calculated by adding or subtracting the reference time period. Specifically, in a case where the first predetermined reference time period is stored as a reference time period, the second predetermined reference time period is obtained by adding a time of a predetermined length to the reference time period. On the other hand, in a case where the second predetermined reference time period is stored as a reference time period, the first predetermined reference time period is obtained by subtracting a time of a predetermined length from the reference time period. Meanwhile, the “time of a predetermined length” which is used for the adding and subtracting can be appropriately changed.

For example, the information processing device 10 further includes a learning unit (not shown) that learns the first predetermined reference time period and the second predetermined reference time period on the basis of a detection interval between symbols, and may be configured such that information stored in the storage unit is updated on the basis of results of the learning of the learning unit. In this case, the learning unit learns an optimized first predetermined reference time period by statistically using a detection interval when symbols are detected in order of a commodity information symbol and a service information symbol. In addition, the learning unit learns an optimized second predetermined reference time period by statistically using a detection interval when symbols are detected in order of a service information symbol and a commodity information symbol. For example, the learning unit calculates an average value, an intermediate value, and the like of detection intervals which are obtained for each operator, and learns the first predetermined reference time period and the second predetermined reference time period for each operator. In addition, the learning unit may learn a first predetermined reference time period and a second predetermined reference time period which are common to a plurality of operators by using an average value, an intermediate value, and the like of results of learning for the operators. In a case where both the first and second predetermined reference time periods are stored in the storage unit, information stored in the storage unit is updated using learning results of the learning unit. In addition, in a case where either the first or second predetermined reference time period is stored in the storage unit, the stored reference time period is updated using learning results of the learning unit. In addition, a difference between the first predetermined reference time period and the second predetermined reference time period which are obtained by the learning of the learning unit may be used as a “time of a predetermined length”.

The display processing unit 150 of the present exemplary embodiment displays commodity information or service information fixed in association on a display unit (not shown). In the present exemplary embodiment, the display processing unit 150 displays information stored in the association storage unit 132 on the display unit as information fixed in association. However, a fixed association is not limited to this example, and a state in which an association of commodity information and service information is determined or a state where it is determined that there is no service information to be associated with commodity information may be set to be a fixed association by the association unit 130. Thereby, the display processing unit 150 displays commodity information and service information which are associated with each other by the association unit 130 on the display unit (not shown). In addition, the display processing unit 150 displays commodity information for which it is determined that there is no service associated therewith by the association unit 130, on the display unit prior to the next commodity information obtained using the next commodity information symbol.

In addition, a sound output unit (not shown) may further (or alternatively) output a predetermined sound indicating the execution of association, in accordance with the execution of association of commodity information and a service information symbol by the association unit 130. An operator can easily ascertain the execution of association by a sound being output by the sound output unit.

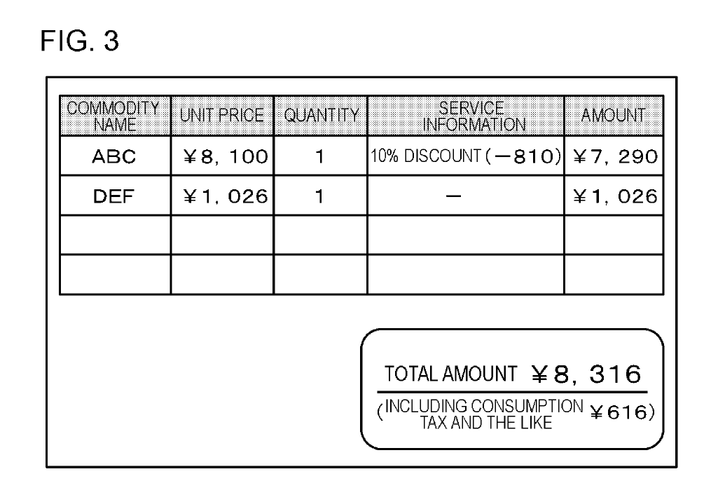

Specifically, the display processing unit 150 ascertains a correspondence relationship between commodity information and service information which are obtained from respective symbols with reference to the association storage unit 132, and displays, for example, a screen as shown in FIG. 3 on the display unit. FIG. 3 is a diagram showing an example of a screen displayed by the display processing unit 150 on the basis of information stored in the association storage unit 132 shown in FIG. 2. A first line of FIG. 3 shows a screen display example related to commodity information and service information (for example, the first line of FIG. 2) which are associated with each other by the association unit 130. In addition, a second line of FIG. 3 shows a screen display example related to commodity information (for example, the second line of FIG. 2) for which it is determined that there is no service information associated therewith. An operator of the information processing device 10 can easily ascertain a correspondence relationship between commodity information and service information by viewing the screen as shown in FIG. 3. For example, in FIG. 3, it is possible to easily determine that service information of “10% discount” is associated with a commodity having a commodity name of “ABC”. In addition, in FIG. 3, it is possible to easily determine that no service information is associated with a commodity having a commodity name of “DEF”. However, FIG. 3 is just an example, and a screen displayed by the display processing unit 150 is not limited to FIG. 3. For example, commodity information and service information may be displayed so as to be divided into the former and latter lines in a determined order (for example, the order of commodity information and service information) rather than being displayed in the same line. In addition, for example, the display processing unit 150 may display the correspondence relationship so as to be identifiable by applying the same color or the same mark to commodity information and service information corresponding to each other among pieces of commodity information and service information displayed on the screen.

The output unit 160 performs a predetermined output for notifying an operator of the information processing device 10 that a commodity information symbol to be detected has not been detected, in accordance with an instruction given from the association unit 130. At least in a case where after a service information symbol is detected and before a second predetermined reference time period elapses, a commodity information symbol is not detected and the next service information symbol is detected, the association unit 130 gives to the output unit 160 an instruction for performing a predetermined output. The output unit 160 receives the instruction from the association unit 130 to perform the predetermined output. For example, the output unit 160 displays a message indicating the occurrence of detection omission of a commodity information symbol, a message for promoting the reading of a commodity information symbol, or the like on the display unit. Thereby, it is possible to notify an operator of the information processing device 10 of the detection omission of a commodity information symbol. In addition, the invention is not limited thereto, and the output unit 160 may output, for example, a predetermined warning sound or the like to notify the operator of the detection omission of a commodity information symbol.

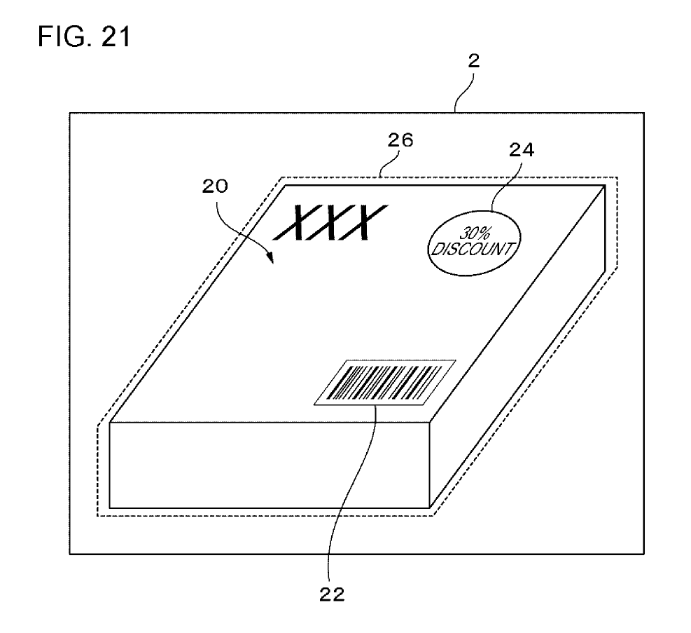

Here, a commodity information symbol detected by the commodity detection unit 110 and a service information symbol detected by the service detection unit 120 will be described with reference to FIG. 21. FIG. 21 is a diagram showing a commodity image 2 obtained by capturing one commodity 20. The commodity image 2 as shown in FIG. 21 is captured by an imaging unit not shown in the drawing. A bar code 22 and a price reduction seal 24 are attached to the commodity 20 seen in the commodity image 2 shown in the example of FIG. 21. The bar code 22 is a form of a commodity information symbol, and the price reduction seal 24 is a form of a service information symbol. The commodity detection unit 110 detects the bar code 22 in the commodity image 2 by using, for example, a known image processing algorithm or the like. Similarly, the service detection unit 120 also detects the price reduction seal 24 in the commodity image 2 by using a known image processing algorithm or the like. Here, a plurality of commodities 20 may be seen in one commodity image 2. In this case, as shown in FIG. 21, the commodity detection unit 110 and the service detection unit 120 specify commodity regions 26 indicating the commodities 20 from the commodity images 2, and detect bar codes 22 and price reduction seals 24 from the specified commodity regions 26. Meanwhile, in the example of FIG. 21, the commodity region 26 indicates a region in which the entire commodity 20 is seen. However, the invention is not limited thereto, and the commodity region may be a region in which a portion of the commodity 20 is seen.

In this manner, the commodity detection unit 110 may be referred to as a first detection unit that detects a first sign that may indicate information (first information: for example, commodity information) which belongs to a first type from a certain image. In addition, the service detection unit 120 may also be referred to as a second detection unit that detects a second sign that may indicate information (second information: for example, service information) which belongs to a second type different from the first type. In this case, in a case where after the first sign is detected and before a first predetermined reference time period elapses, the second sign is detected, the association unit 130 associates first information obtained using the first sign with second information obtained using the second sign. In addition, in a case where after the second sign is detected and before a second predetermined reference time period longer than the first predetermined reference time period elapses, the first sign is detected, the association unit 130 associates the first information obtained using the first sign with the second information obtained using the second sign. The association unit 130 may also be referred to as an output unit by further outputting the first information and the second information associated with each other.

[Hardware Configuration]

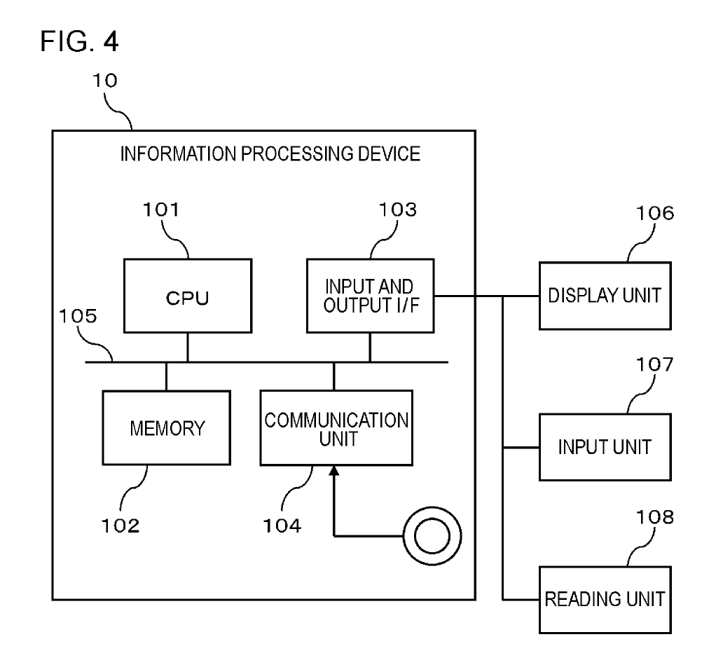

FIG. 4 is a schematic diagram showing an example of a hardware configuration of the information processing device in the first exemplary embodiment. As shown in FIG. 4, the information processing device 10 includes a central processing unit (CPU) 101, a memory 102, an input and output interface (I/F) 103, a communication unit 104, and the like. The CPU 101 is connected to other units through a communication line such as a bus 105. The memory 102 is a random access memory (RAM), a read only memory (ROM), a flash memory, or the like. The communication unit 104 transmits and receives a signal to and from other devices or apparatuses. A portable recording medium and the like may also be connected to the communication unit 104. The input and output I/F 103 is connected to a display unit 106, an input unit 107, the reading unit 108, and the like.

The display unit 106 is a unit that displays a screen, such as a liquid crystal display (LCD) or a cathode ray tube (CRT) display, which corresponds to drawing data which is processed by the CPU 101, a graphics processing unit (GPU) (not shown), or the like. The input unit 107 is a unit that receives a user's operation input, and is configured as, for example, a hardware button unit, a touch sensor, or the like. The display unit 106 and the input unit 107 may be integrally formed to be configured as a touch panel. The reading unit 108 is a camera which is constituted by a lens, an imaging element, and the like, and generates one still image captured at a certain moment or a plurality of still images captured over a fixed period of time. The plurality of still images captured over a fixed period of time may be a so-called moving image, or may be images obtained by simply capturing a still image at a plurality of timings. In addition, the reading unit 108 may be a symbol reading device, such as a bar code reader, which is constituted by a light source, a light receiving element, and the like. The commodity detection unit 110 and the service detection unit 120 which are mentioned above detect a commodity information symbol and a service information symbol by using information acquired from the reading unit 108.

A hardware configuration of the information processing device 10 is not limited to a configuration shown in FIG. 4. The information processing device 10 may further include a component other than components shown in FIG. 4. In addition, the information processing device 10 may not include the display unit 106, the input unit 107, and the reading unit 108. In this case, the information processing device 10 communicates with another external device through the communication unit 104 to display drawing data on a display unit of another device, to receive a user's input operation through an input unit of another device, and to acquire information read by a reading unit of another device. In addition, the information acquired by the information processing device 10 from the reading unit of another device may be information indicating a commodity information symbol and a service information symbol themselves, or may be commodity information and service information which are obtained using a commodity information symbol and a service information symbol.

The processing units (the commodity detection unit 110, the service detection unit 120, the association unit 130, the monitoring unit 140, the display processing unit 150, and the output unit 160) of the information processing device 10 described above are achieved, for example, by the execution of programs stored in the memory 102 by the CPU 101. The programs are installed from a portable recording medium, such as a compact disc (CD) or a memory card, or another computer on a network through the communication unit 104 or the like, and are stored in the memory 102. The CPU 101 executes programs, stored in the memory 102, for achieving functions of the commodity detection unit 110, the service detection unit 120, the association unit 130, the monitoring unit 140, the display processing unit 150, and the output unit 160, and thus the commodity detection unit 110, the service detection unit 120, the association unit 130, the monitoring unit 140, the display processing unit 150, and the output unit 160 are achieved. In addition, the association storage unit 132 is achieved by a storage (not shown) such as a hard disk drive (HDD) or a solid state drive (SSD).

### Operational Example

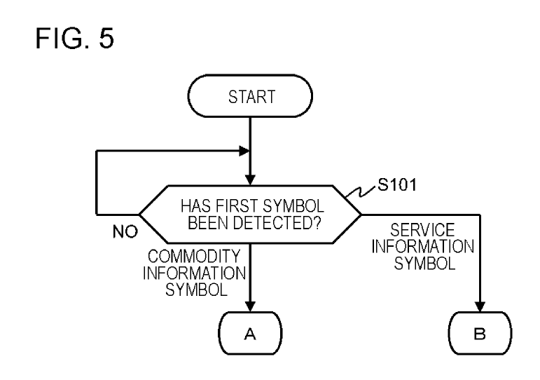

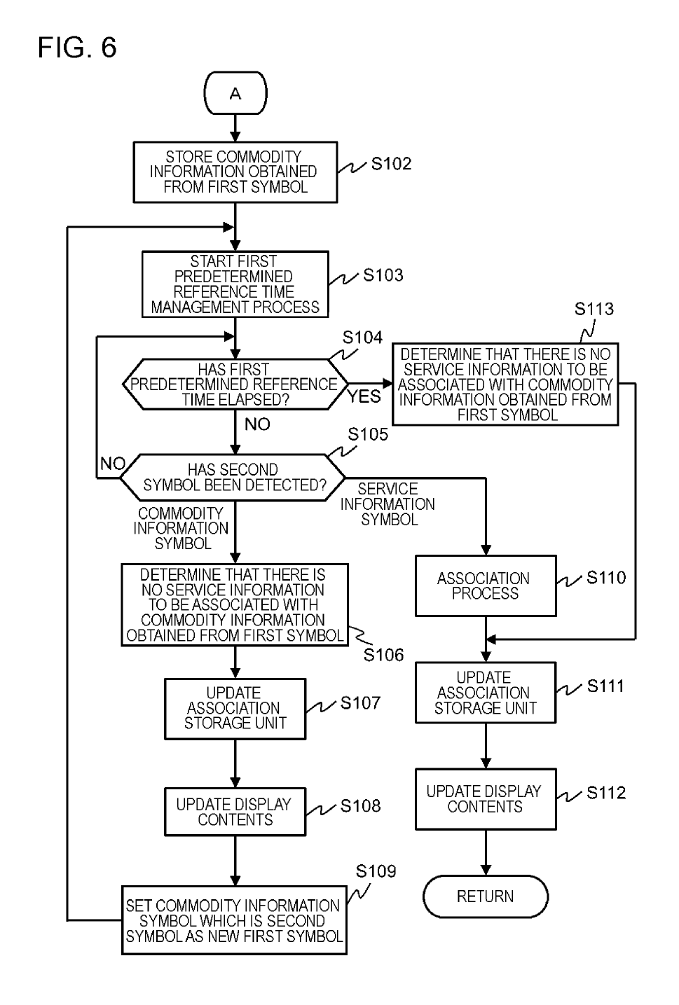

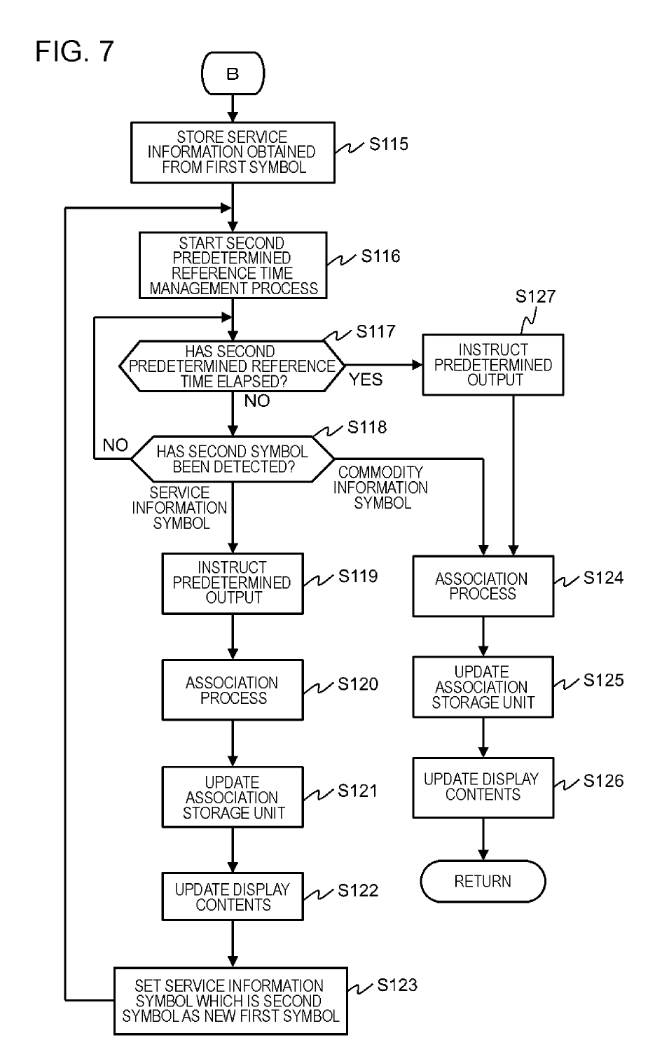

An operational example of the information processing device in the present exemplary embodiment will be described with reference to FIGS. 5 to 7. FIG. 5 is a flow chart showing a flow of a process in which the information processing device in the first exemplary embodiment detects a first symbol. FIG. 6 is a flow chart showing a flow of a process of the information processing device in the first exemplary embodiment in a case where a commodity information symbol is detected as a first symbol in FIG. 5. FIG. 7 is a flow chart showing a flow of the information processing device in the first exemplary embodiment in a case where a service information symbol is detected as a first symbol in FIG. 5.

First, processes of detecting symbols which are performed by the commodity detection unit 110 and the service detection unit 120 are asynchronously performed in parallel. Information regarding each symbol detected by either the commodity detection unit 110 or the service detection unit 120 is sequentially transmitted toward the association unit 130. The association unit 130 receives information regarding each symbol from the commodity detection unit 110 or the service detection unit 120 to thereby determine whether or not a first symbol has been detected (S101). Here, the wording “first symbol” as used herein refers to a symbol which is previously detected out of two symbols which are targets for determination of association in this process. Specifically, in a case where a commodity information symbol is previously detected by the commodity detection unit 110 before a service information symbol is detected by the service detection unit 120, the commodity information symbol serves as a first symbol. On the other hand, in a case where a commodity information symbol is previously detected by the service detection unit 120 before a commodity information symbol is detected by the commodity detection unit 110, the service information symbol serves as a first symbol. In a case where a commodity information symbol is detected as a first symbol (S101: commodity information symbol), the process proceeds to A. On the other hand, in a case where a service information symbol is detected as a first symbol (S101: service information symbol), the process proceeds to B.

<Process A>

The association unit 130 stores commodity information obtained from the first symbol (commodity information symbol) detected in S101 in the association storage unit 132 (S102).

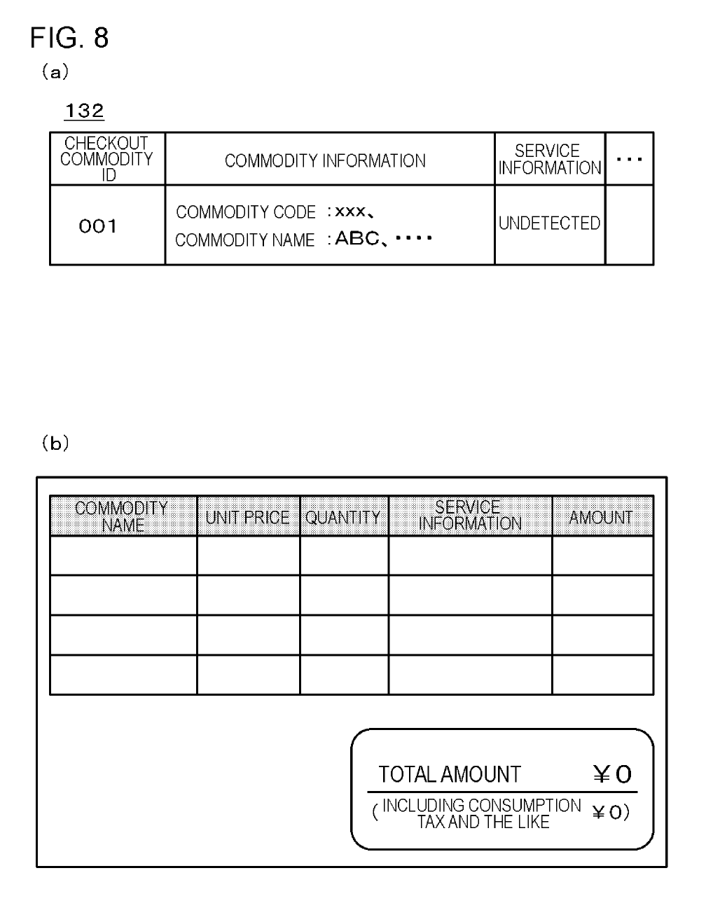

A specific example thereof will be described with reference to FIG. 8. FIG. 8 is a diagram showing information stored in the association storage unit and a screen displayed on the display unit. The association unit 130 stores commodity information obtained from the first symbol detected in S101 in the association storage unit 132, as shown in FIG. 8(a). Meanwhile, as shown in FIG. 8(a), service information associated with commodity information at this point in time is set to be in an “undetected” state, and association of the commodity information has not been fixed. For this reason, as shown in FIG. 8(b), commodity information obtained from the first symbol detected in S101 is not displayed on the screen at this point in time.

The monitoring unit 140 starts a process (first predetermined reference time period management process) of managing whether or not a first predetermined reference time period has elapsed from the detection of the first symbol, in response to the detection of the first symbol (commodity information symbol) (S103). Specifically, the monitoring unit 140 manages a time elapsed from the detection of the first symbol, for example, by starting up a timer for determining the elapse of the first predetermined reference time period in response to the detection of the first symbol. In a case where the monitoring unit 140 determines that the first predetermined reference time period has elapsed from the detection of the commodity information symbol by using, for example, the first predetermined reference time period which is stored in a storage unit not shown in the drawing in advance or which is calculated on the basis of a reference time period, the monitoring unit notifies the association unit 130 of the elapse of the first predetermined reference time period. The association unit 130 determines the elapse of the first predetermined reference time period on the basis of the notification (S104). The association unit 130 determines, until the first predetermined reference time period elapses from the detection of the first symbol (S104: NO), whether or not a second symbol has been detected by either the commodity detection unit 110 or the service detection unit 120 (S105). Here, the wording “second symbol” as used herein refers to a symbol which is detected later out of two symbols which are targets for determination of association in this process. Specifically, commodity information symbols or service information symbols which are detected until the first predetermined reference time period elapses from the detection of the first symbol are set as second symbols.

Here, an operator performing a commodity checkout operation in a store generally performs an operation of reading a commodity information symbol or a service information symbol for each commodity. For this reason, there is a high possibility of commodity information symbols or service information symbols being sequentially detected for each commodity. That is, when the next commodity information symbol is detected after a certain commodity information symbol is detected, the association unit 130 can infer that the next commodity is an object to be processed. Here, it is assumed that, after a certain commodity information symbol is detected and before a first predetermined reference time period elapses, a service information symbol has not been detected and the next commodity information symbol has been detected. In this case, the association unit 130 determines that an object to be processed proceeds to the next commodity, and thus it is possible to infer that there is a high possibility that there is no service information symbol corresponding to the commodity information symbol previously detected. Consequently, in a case where a commodity information symbol is detected as a second symbol (S105: commodity information symbol), the association unit 130 determines that there is no service information to be associated with commodity information obtained from the commodity information symbol which is a first symbol (S106). The association unit 130 updates the association storage unit 132 on the basis of the determination performed in S106 and commodity information obtained from the second symbol detected in S105 (S107). The display processing unit 150 updates display contents of the display unit 106 on the basis of information stored in the association storage unit 132 (S108).

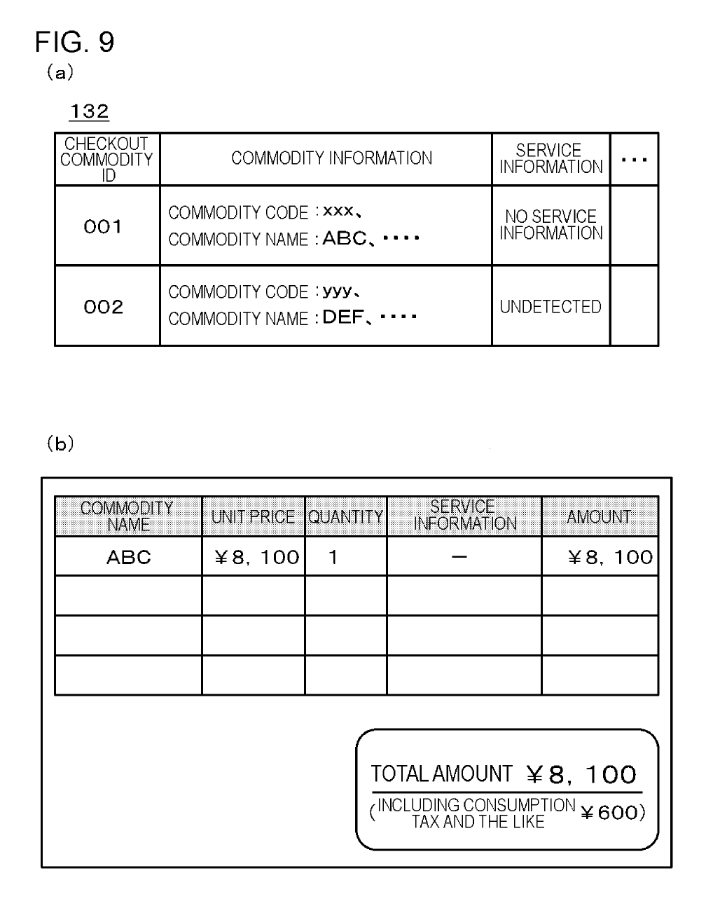

A specific example thereof will be described with reference to FIG. 9. FIG. 9 is a diagram showing information stored in the association storage unit and a screen displayed on the display unit. The association unit 130 updates information stored in the association storage unit 132 as shown in FIG. 9(a). In detail, the association unit 130 newly stores commodity information obtained from the commodity information symbol detected in S106 in the association storage unit 132, as shown in a second line of FIG. 9(a). Meanwhile, similarly to the case of FIG. 8, service information associated with the new commodity information at this point in time is set to be in an “undetected” state, and association of the commodity information has not been fixed. On the other hand, regarding the commodity information stored first in S102, the association unit 130 adds information (“no service information”) indicating that there is no service information to be associated, as shown in a first line of FIG. 9(a). Thereby, the association of the former commodity information obtained from the first symbol detected in S101 is fixed. For this reason, even when it is assumed that a service information symbol is detected later at a timing within a first predetermined reference time period with respect to two commodity information symbols, service information obtained from the service information symbol is associated with commodity information obtained from the latter commodity information symbol. The display processing unit 150 displays, for example, the screen as shown in FIG. 9(b) on the display unit 106 on the basis of the information as shown in FIG. 9(a). Here, the former commodity information fixed in association is displayed on the display unit 106.

In addition, regarding commodity information (for example: the second line of FIG. 9(a)) which is obtained from a commodity information symbol which is a second symbol, there is the possibility that a service information symbol is later detected and then an association process is performed. For this reason, the association unit 130 sets the commodity information symbol which is a second symbol as a new first symbol (S109) to proceed to the process in S103 and repeat the above-described process. When the above-described process is repeated, the monitoring unit 140 manages an elapsed time on the basis of a timing when the second symbol (that is, a new first symbol) is detected. Accordingly, the first predetermined reference time period management process regarding the former first symbol is stopped.

In addition, an operator performing a commodity checkout operation generally performs an operation of reading a commodity information symbol or a service information symbol for each commodity. For this reason, it is considered that there is a high possibility that a commodity information symbol and a service information symbol which are attached to the same commodity are detected at timings close to each other to a certain extent. The wording “timings close to each other to a certain extent” as used herein refer to timings serving as indexes for determining a first predetermined reference time period, and can be empirically or theoretically calculated. In other words, in a case where a commodity information symbol and a service information symbol are detected within the first predetermined reference time period, it can be said that there is a high possibility that commodity information and service information which are obtained from the respective symbols are associated with each other. Consequently, in a case where a service information symbol is detected as a second symbol before the first predetermined reference time period elapses (S105: service information symbol), the association unit 130 performs a process of associating the commodity information and the service information, which are obtained from the respective symbols, with each other (S110). The association unit 130 updates the association storage unit 132 on the basis of results of the association process in S110 (S111). The display processing unit 150 updates display contents of the display unit 106 on the basis of association information stored in the association storage unit 132 (S112).

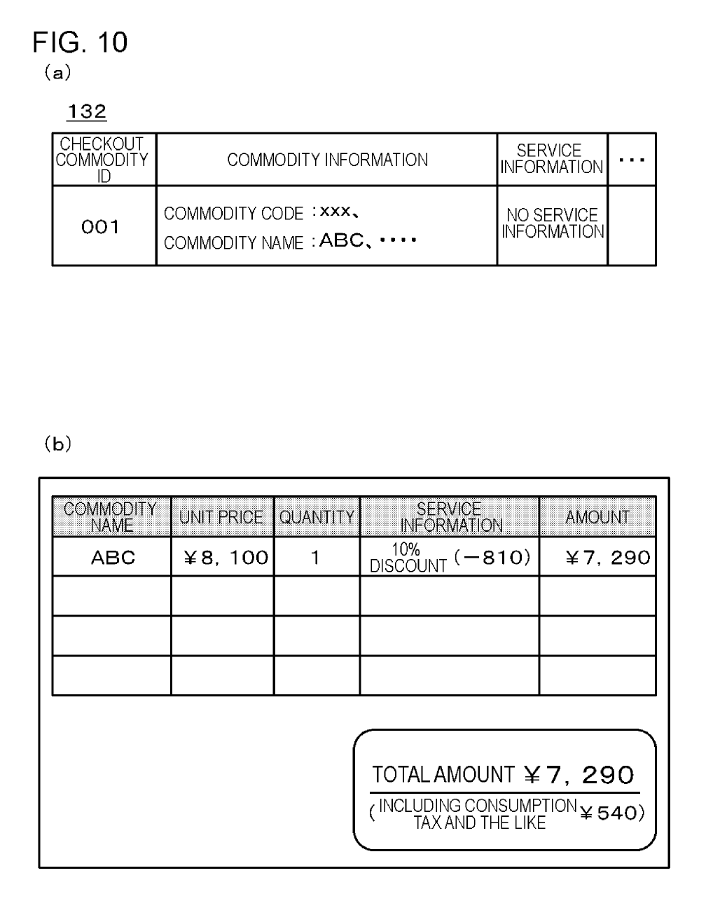

A specific example thereof will be described with reference to FIG. 10. FIG. 10 is a diagram showing information stored in the association storage unit and a screen displayed on the display unit. The association unit 130 updates information stored in the association storage unit 132 on the basis of results of the association process in S110, as shown in FIG. 10(a). In detail, the association unit 130 associates service information obtained from the second symbol (service information symbol) with the commodity information stored in S102. Thereby, association of commodity information obtained from the first symbol detected in S101 and service information obtained from the second symbol detected in S105 is fixed. The display processing unit 150 displays the commodity information and the service information fixed in association with each other on the display unit 106, as shown in, for example, FIG. 10(b).

In addition, in a case where the first predetermined reference time period elapses (S104: YES) in a state where the second symbol has not been detected (S105: NO), the association unit 130 determines that there is no service information to be associated with commodity information obtained from the commodity information symbol which is a first symbol (S113). This is based on the above-mentioned idea that “there is a high possibility that a commodity information symbol and a service information symbol which are attached to the same commodity are detected at timings close to each other to a certain extent”. The association unit 130 updates the association storage unit 132 on the basis of the determination in S113 (S111). The display processing unit 150 updates display contents of the display unit 106 on the basis of association information stored in the association storage unit 132 (S112).

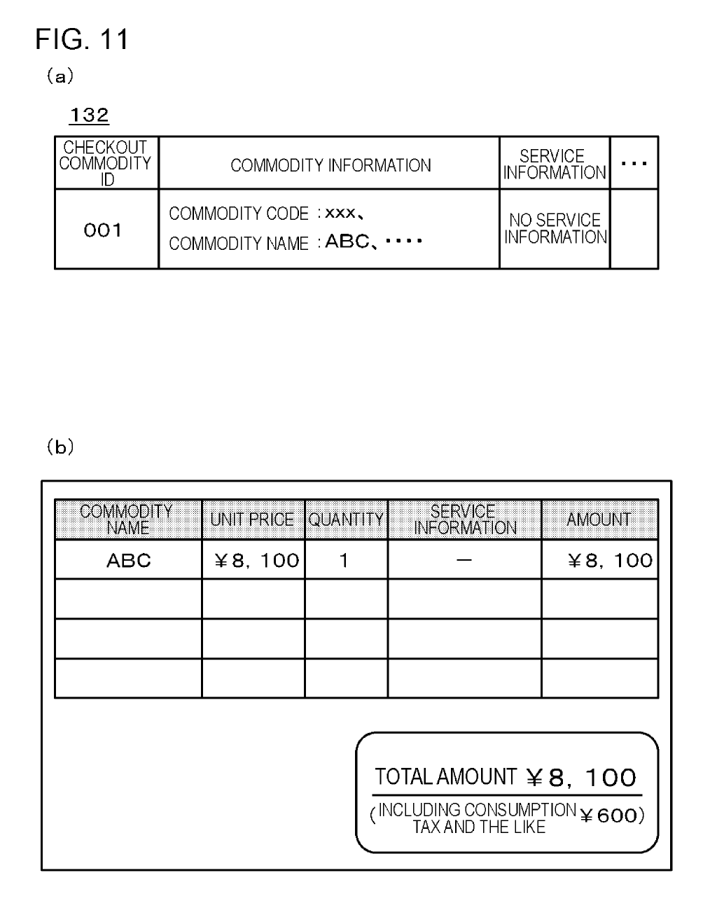

A specific example thereof will be described with reference to FIG. 11. FIG. 11 is a diagram showing information stored in the association storage unit and a screen displayed on the display unit. The association unit 130 updates information stored in the association storage unit 132 on the basis of the determination in S113, as shown in FIG. 11(a). In detail, the association unit 130 adds information (“no service information”) indicating there is no service information to be associated, to the commodity information previously stored in S102. Thereby, association of commodity information obtained from the first symbol detected in S101 is fixed. The display processing unit 150 displays, for example, the screen as shown in FIG. 11(b) on the display unit 106 on the basis of the information as shown in FIG. 11(a).

In a case where it is determined that association of commodity information and service information is performed in S110 or it is determined that there is no service information to be associated with commodity information obtained from the commodity information symbol which is a first symbol in S113, a symbol to be detected next is set as a first symbol. For this reason, in a case where it is determined that association of commodity information and service information is performed in S110 or it is determined that there is no service information to be associated with commodity information obtained from the commodity information symbol which is a first symbol in S113, the process returns to S101. Meanwhile, a flow of the series of processes is repeated until a commodity checkout operation for a certain customer is completed.

<Process B>

The association unit 130 stores service information obtained from the first symbol (service information symbol) detected in S101 in the association storage unit 132 (S116).

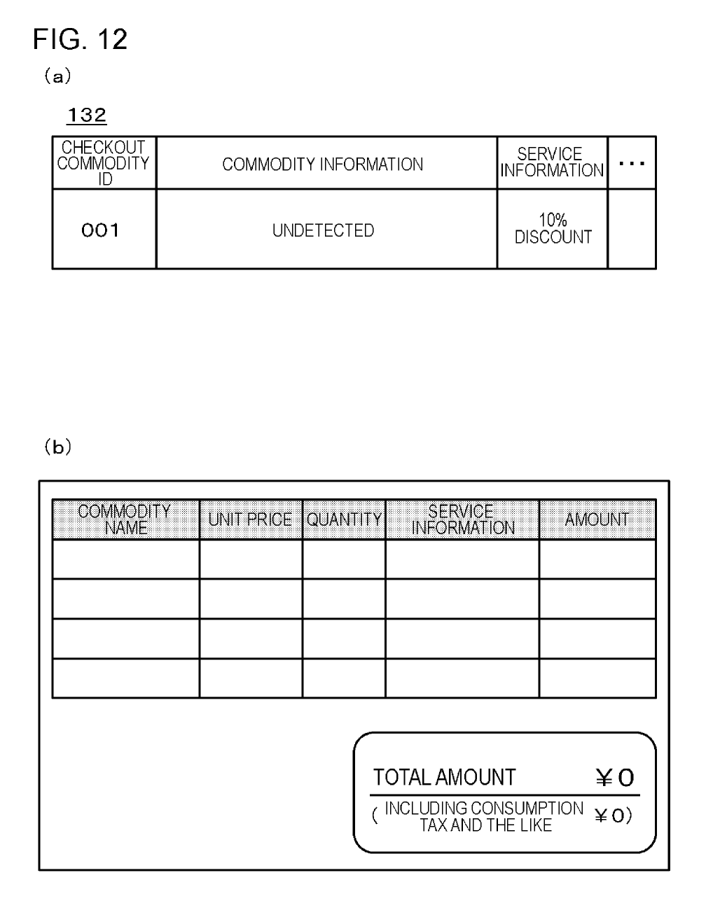

A specific example thereof will be described with reference to FIG. 12. FIG. 12 is a diagram showing information stored in the association storage unit and a screen displayed on the display unit. The association unit 130 stores service information obtained from the first symbol detected in S101 in the association storage unit 132, as shown in FIG. 12(a). Meanwhile, as shown in FIG. 12(a), commodity information associated with the service information at this point in time is set to be in an “undetected” state, and association of the service information has not been fixed. For this reason, as shown in FIG. 12(b), service information obtained from the first symbol detected in S101 is not displayed on a screen at this point in time.

The monitoring unit 140 starts a process of managing a time elapsed from the detection of a first symbol (second predetermined reference time period management process) in response to the detection of the first symbol (service information symbol) (S116). Specifically, the monitoring unit 140 manages a time elapsed from the detection of the first symbol, for example, by starting up a timer for determining the elapse of the second predetermined reference time period in response to the detection of the first symbol. In a case where the monitoring unit 140 determines that the second predetermined reference time period has elapsed from the detection of the commodity information symbol by using, for example, the second predetermined reference time period which is stored in a storage unit not shown in the drawing in advance or which is calculated on the basis of a reference time period, the monitoring unit notifies the association unit 130 of the elapse of the second predetermined reference time period. The association unit 130 determines the elapse of the second predetermined reference time period on the basis of the notification (S104). The association unit 130 determines, until the second predetermined reference time period elapses from the detection of the first symbol (S117: NO), whether or not a second symbol has been detected by either the commodity detection unit 110 or the service detection unit 120 (S118). These processes are the same as those in a case of the above-described process A.

Here, as described above, an operator performing a commodity checkout operation generally performs an operation of reading a commodity information symbol or a service information symbol for each commodity. For this reason, it is considered that there is a high possibility that a commodity information symbol and a service information symbol which are attached to the same commodity are detected at timings close to each other to a certain extent. Further, with respect to commodity information, service information to be applied may not be present. However, with respect to service information, a commodity which is a target of a service is necessarily present, and thus an association process is performed. For this reason, the second predetermined reference time period is set to be longer than the first predetermined reference time period. In a case where a commodity information symbol is detected as a second symbol before the second predetermined reference time period elapses (S118: commodity information symbol), the association unit 130 performs a process of associating commodity information and service information obtained from the respective symbols with each other (S124). The association unit 130 updates the association storage unit 132 on the basis of results of the association process in S124 (S125). The display processing unit 150 updates display contents of the display unit 106 on the basis of association information stored in the association storage unit 132 (S126).

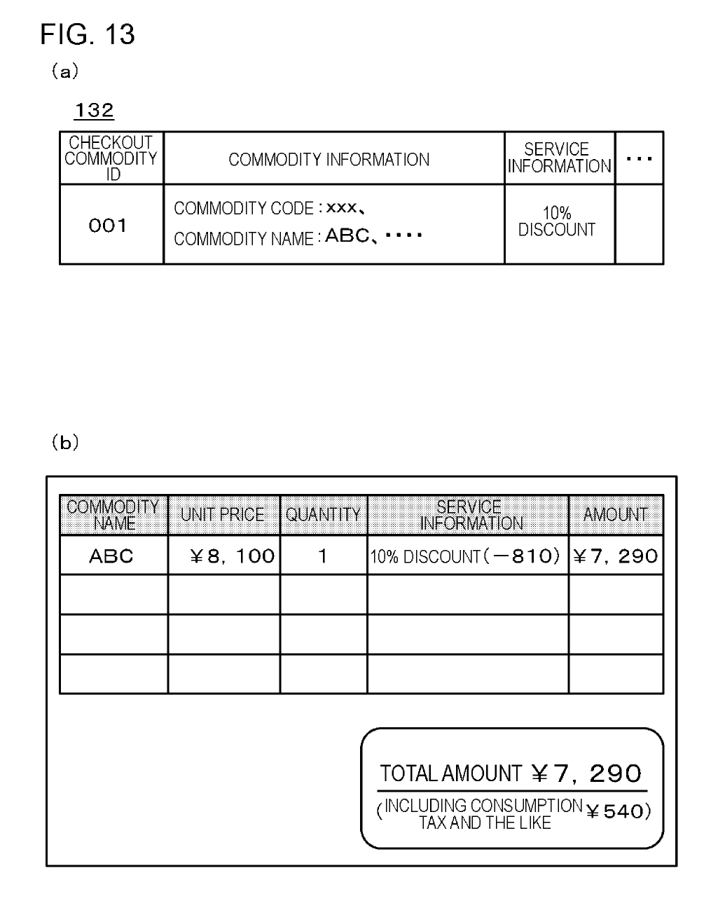

A specific example thereof will be described with reference to FIG. 13. FIG. 13 is a diagram showing information stored in the association storage unit and a screen displayed on the display unit. The association unit 130 updates information stored in the association storage unit 132 on the basis of results of the association process in S124, as shown in FIG. 13(a). In detail, the association unit 130 associates commodity information obtained from the second symbol (commodity information symbol) with the service information stored in S115. Thereby, association of service information obtained from the first symbol detected in S101 and commodity information obtained from the second symbol detected in S118 is fixed. The display processing unit 150 displays the service information and the commodity information fixed in association with each other on the display unit 106, as shown in, for example, FIG. 13(b).

In addition, as described above, a commodity information symbol and a service information symbol are sequentially detected for each commodity, and a commodity which is a target of a service is necessarily present with respect to service information. For this reason, the next commodity is set as an object to be processed at a point in time when the next service information symbol is detected, and thus it can be determined that a commodity information symbol regarding a commodity having the former service information symbol attached thereto has not been detected. Consequently, in a case where a service information symbol is detected as a second symbol (S118: service information symbol), the association unit 130 determines that detection omission of a commodity information symbol has occurred, and transmits an instruction for performing a predetermined output to the output unit 160 (S119).

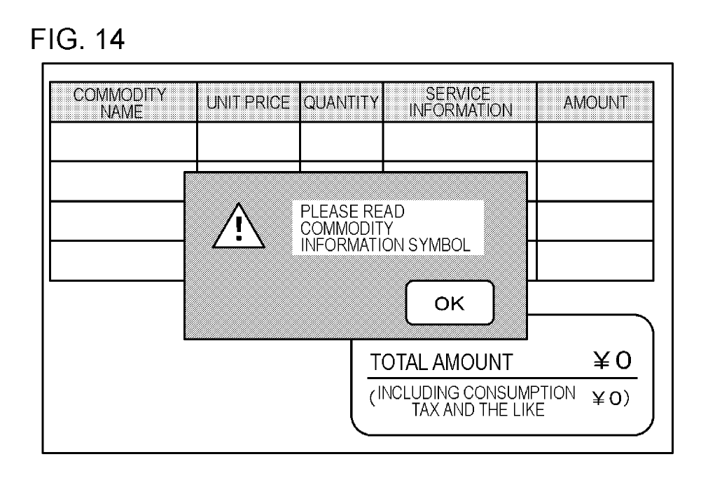

The output unit 160 displays, for example, a message indicating the occurrence of detection omission of a commodity information symbol, a message for promoting the reading of a commodity information symbol, or the like on the display unit 106, as the predetermined output in S119. As a specific example, the output unit 160 displays a message as shown in FIG. 14 on the display unit 106. FIG. 14 is a diagram showing a predetermined output of the output unit 160. An operator of the information processing device 10 can perceive the occurrence of detection omission of commodity information by an output such as the message. An operation of reading a commodity information symbol corresponding to a service information symbol detected as a first symbol is performed by the operator having viewed the message. In this manner, commodity information associated with service information obtained from the service information symbol detected as a first symbol is correctly acquired. However, the output of the output unit 160 in S119 is not limited to the above-described example. In S120, information regarding the detection of a commodity information symbol corresponding to a service information symbol may be output. For example, the output unit 160 may notify an operator of the detection omission of a commodity information symbol by outputting a predetermined warning sound, or the like.

The association unit 130 associates service information obtained from the service information symbol which is a first symbol with commodity information obtained from a commodity information symbol which is read in accordance with the output in S119 (S120). The association unit 130 updates the association storage unit 132 on the basis of association information indicating association of the service information obtained from the first symbol and the commodity information obtained from the commodity information symbol which is read in accordance with the output in S119 (S121). The display processing unit 150 updates display contents of the display unit 106 on the basis of association information stored in the association storage unit 132 (S122).

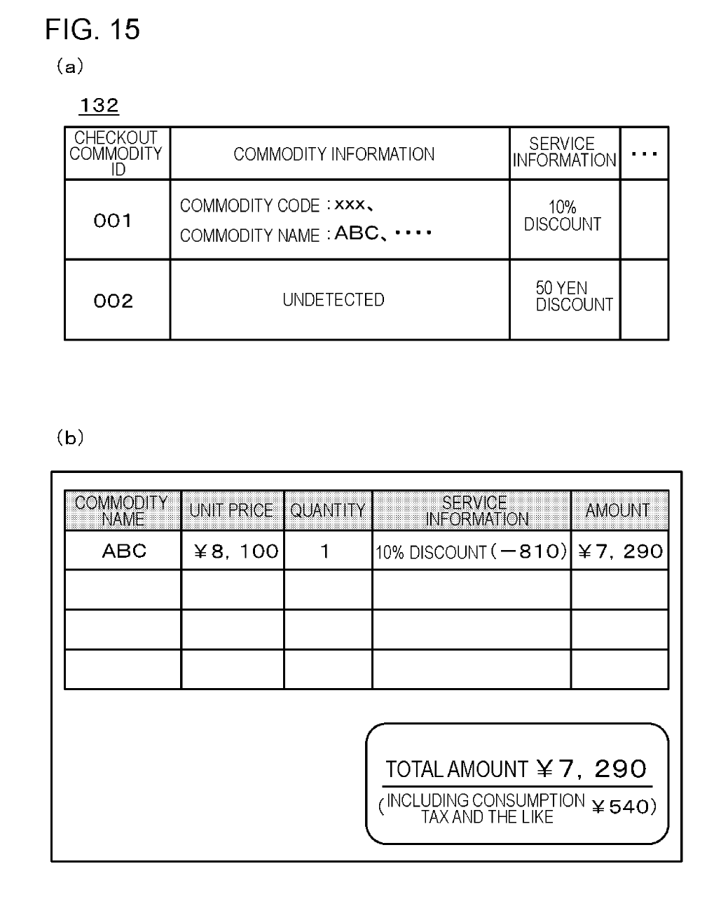

A specific example thereof will be described with reference to FIG. 15. FIG. 15 is a diagram showing information stored in the association storage unit and a screen displayed on the display unit. The association unit 130 updates information stored in the association storage unit 132, as shown in FIG. 15(a). In detail, the association unit 130 newly stores service information obtained from the service information symbol detected in S118 in the association storage unit 132, as shown in a second line of FIG. 15(a). Meanwhile, similarly to a case of FIG. 12, commodity information associated with the new service information at this point in time is set to be in an “undetected” state, and the association of the service information has not been fixed. On the other hand, the association unit 130 associates commodity information, obtained from the commodity information symbol which is read by the output in S119, with the service information previously stored in S115, as shown in a first line of FIG. 15(a). Thereby, association of the previous service information obtained from the first symbol detected in S101 is fixed. The display processing unit 150 displays, for example, a screen as shown in FIG. 15(b) on the display unit 106 on the basis of the information as shown in FIG. 15(a). Here, the previous service information and commodity information fixed in association with each other are displayed on the display unit 106.

In addition, regarding service information obtained from a service information symbol which is a second symbol, there is a possibility that a commodity information symbol is detected later and then an association process is performed. For this reason, the association unit 130 sets the service information symbol which is a second symbol as a new first symbol (S123) to proceed to the process in S116 and repeat the above-described process. When the above-described process is repeated, the monitoring unit 140 manages an elapsed time on the basis of a timing when the second symbol (that is, a new first symbol) is detected. Accordingly, the second predetermined reference time period management process regarding the first symbol is stopped.

In addition, it is considered that detection omission of a commodity information symbol with respect to service information symbol detected as a first symbol occurs even when the second predetermined reference time period elapses (S117: YES) in a state where a second symbol is not detected (S118: NO). Accordingly, the association unit 130 transmits an instruction for performing a predetermined output to the output unit 160, similar to a case where after a certain service information symbol is detected and before the second predetermined reference time period elapses, a commodity information symbol is not detected and the next service information symbol is detected (S127). A commodity information symbol corresponding to the service information symbol which is a first symbol is read by an operator having viewed an output of the output unit 160. The association unit 130 associates service information obtained from the first symbol with commodity information obtained from the commodity information symbol which is read in S127, in accordance with the reading of the commodity information symbol (S124). The association unit 130 updates the association storage unit 132 on the basis of the service information obtained from the first symbol and association information indicating the association of the commodity information obtained from the commodity information symbol which is read in accordance with the output in S127 (S125). The display processing unit 150 updates display contents of the display unit 106 on the basis of association information stored in the association storage unit 132 (S126). Specifically, the same process as in the example of FIG. 13 is performed using commodity information obtained from the commodity information symbol which is read by the output in S127.

In a case where a process of associating commodity information and service information with each other is performed in S124, a symbol to be detected next is a first symbol. For this reason, in a case where the process of associating commodity information and service information with each other is performed in S124, the process returns to S101. Meanwhile, a flow of the series of processes is repeated until a commodity checkout operation for a certain customer is completed.

As described above, in the present exemplary embodiment, processes of detecting a commodity information symbol and a service information symbol are asynchronously performed in parallel. Thereby, it is possible to facilitate a user's operation of holding a commodity information symbol and a service information symbol over the reading unit 108 and to reduce a time until both the symbols are detected, as compared with a configuration in which a service information symbol is detected after a commodity information symbol is detected. However, accordingly, the detected order of the commodity information symbol and the service information symbol is not fixed.

Consequently, in the present exemplary embodiment, in a case where a service information symbol is detected before a first predetermined reference time period elapses after a commodity information symbol is detected, commodity information and service information obtained using the respective detected symbols are associated with each other. In addition, in a case where a commodity information symbol is detected before a second predetermined reference time period elapses after a service information symbol is detected, commodity information and service information obtained using the respective detected symbols are associated with each other. Here, an operator performing a commodity checkout operation generally performs an operation of reading a commodity information symbol or a service information symbol for each commodity. For this reason, there is a high possibility that a commodity information symbol and a service information symbol which are attached to the same commodity are detected at timings close to each other to a certain extent. In other words, in a case where a commodity information symbol and a service information symbol are detected within the first or second predetermined reference time period, commodity information and service information included in the respective symbols are pieces of information regarding one commodity, and it can be said that there is a high possibility that the pieces of information have a correspondence relationship. According to the present exemplary embodiment, it is determined whether or not commodity information and service information are associated with each other by using the first predetermined reference time period and the second predetermined reference time period. For this reason, it is possible to correctly associate commodity information and service information regarding the same commodity with each other even when the detected order of a commodity information symbol and a service information symbol is not fixed.

Further, the second predetermined reference time period which is used when a service information symbol is previously detected is set to be longer than the first predetermined reference time period which is used when a commodity information symbol is previously detected. Here, a commodity having only a commodity information symbol attached thereto and having no service information symbol attached thereto is present, but a commodity having only a service information symbol attached thereto and having no commodity information symbol attached thereto is not present in a normal state. That is, with respect to commodity information, service information to be associated therewith may not be present. However, with respect to service information, a commodity which is a target of a service is necessarily present, and thus commodity information to be associated therewith is present in a normal state. Accordingly, there is an increasing possibility that commodity information can be associated with service information which is previously acquired by setting a long second predetermined reference time period in this manner, and thus it is possible to perform the association process with a high level of accuracy.

### Second Exemplary Embodiment

As solving means of the above-described problems, an information processing device 10 may include at least a commodity detection unit 110, a service detection unit 120, and an association unit 130 without being limited to the configuration of the first exemplary embodiment.

[Processing Configuration]

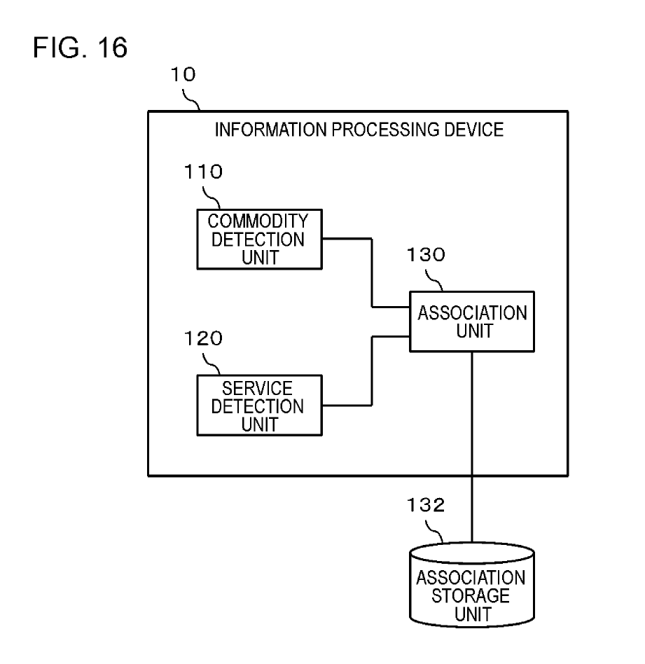

FIG. 16 is a schematic diagram showing a processing configuration of an information processing device in a second exemplary embodiment. As shown in FIG. 16, an information processing device 10 of the second exemplary embodiment includes a commodity detection unit 110, a service detection unit 120, and an association unit 130. The processing units (the commodity detection unit 110, the service detection unit 120, and the association unit 130) of the information processing device 10 are achieved by a CPU 101 executing programs for achieving functions of the processing units, similar to the first exemplary embodiment. In addition, an association storage unit 132 is configured by a storage (not shown) such as an HDD or an SSD, similar to the first exemplary embodiment.

The commodity detection unit 110 detects a commodity information symbol, and the service detection unit 120 detects a service information symbol. The operations of the commodity detection unit 110 and the service detection unit 120 are the same as those in the first exemplary embodiment, and thus a detailed description thereof will not be repeated.

Similarly to the first exemplary embodiment, the association unit 130 determines a correspondence relationship between commodity information and service information which are obtained using respective symbols detected by the commodity detection unit 110 or the service detection unit 120. In the present exemplary embodiment, the association unit 130 manages whether a first predetermined reference time period has elapsed from the detection of a commodity information symbol or whether a second predetermined reference time period has elapsed from the detection of a service information symbol. Specifically, the association unit 130 of the present exemplary embodiment compares detection times of two symbols which are sequentially detected, to thereby determine a time elapsed from the detection of the previous symbol until the detection of the next symbol. In addition, in a case where after the previous symbol is detected, the next symbol is not detected, the association unit 130 compares a present time and a detection time of the previous symbol with each other to thereby determine a time elapsed from the detection of the previous symbol. The association unit 130 compares the elapsed time determined as described above with a first threshold time Tₜₕ₁ or a second threshold time Tₜₕ₂ (Tₜₕ₁<Tₜₕ₂) which is set in advance to thereby determine whether or not a first predetermined reference time period or a second predetermined reference time period has elapsed. Here, the first threshold time Tₜₕ₁ is equivalent to the first predetermined reference time period in the first exemplary embodiment. In addition, the second threshold time Tₜₕ₂ is equivalent to the second predetermined reference time period in the first exemplary embodiment. However, a method in which the association unit 130 manages the elapse of the first predetermined reference time period and the second predetermined reference time period is not limited to this method.

### Operational Example

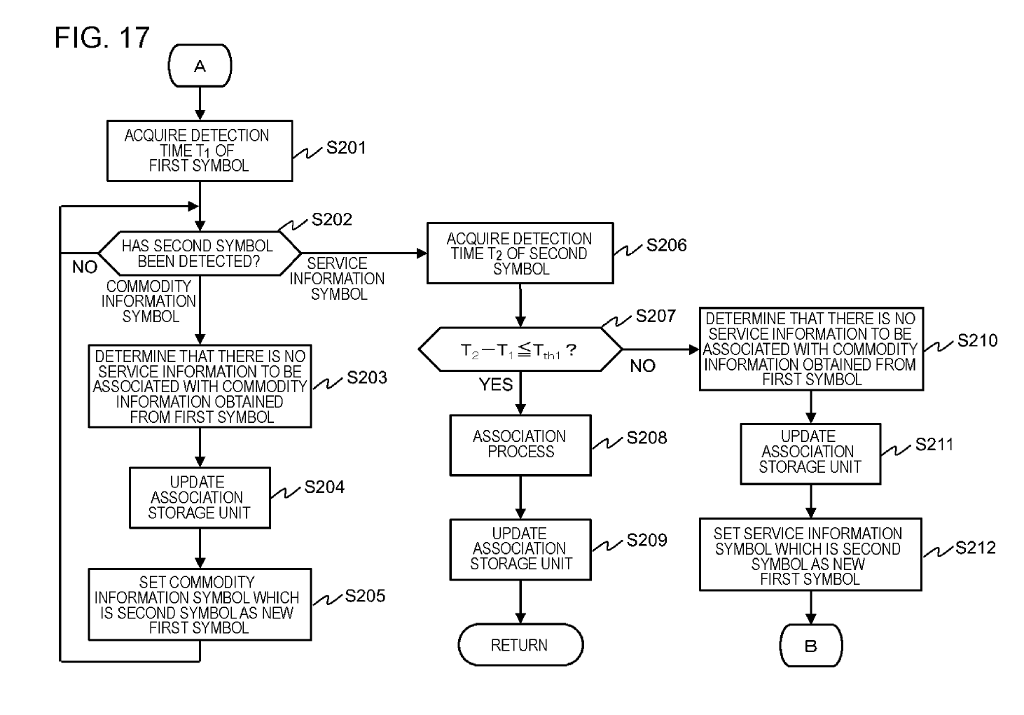

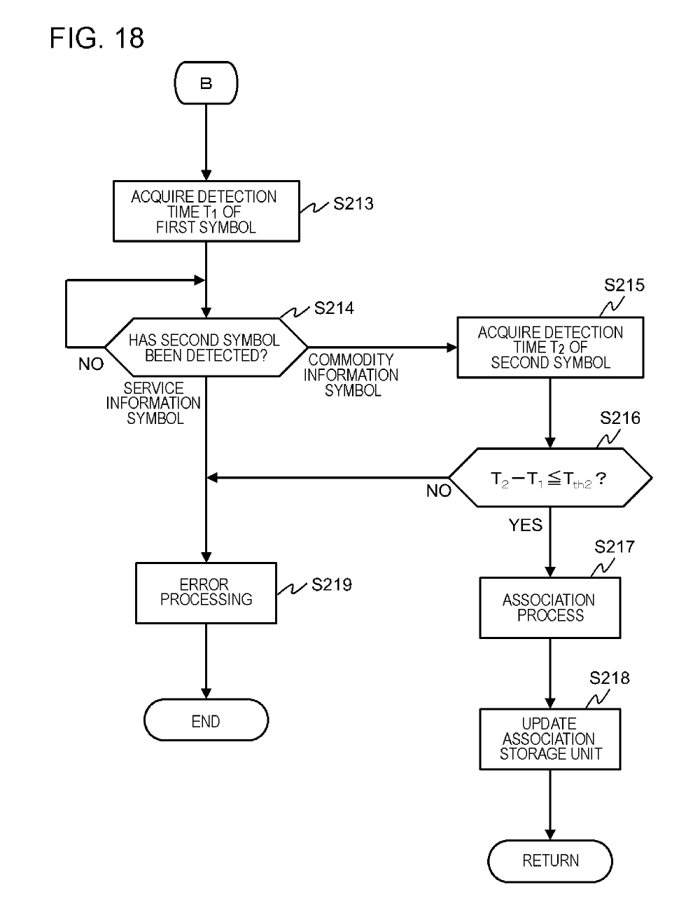

An operational example of the information processing device in the present exemplary embodiment will be described with reference to FIGS. 17 and 18. FIG. 17 is a flow chart showing a flow of a process of the information processing device in the second exemplary embodiment in a case where a commodity information symbol is detected as a first symbol in FIG. 5. FIG. 18 is a flow chart showing a flow of a process of the information processing device in the second exemplary embodiment in a case where a service information symbol is detected as a first symbol in FIG. 5. Meanwhile, the process, shown in FIG. 5, which is described in the first exemplary embodiment is common to the present exemplary embodiment.

<Process A>

The association unit 130 acquires a detection time T₁ of a first symbol (commodity information symbol) in accordance with the detection of the first symbol (S201). The association unit 130 further acquires the detection time T₁ of the commodity information symbol from, for example, the commodity detection unit 110. The invention is not limited thereto, and the association unit 130 may also determine the detection time T₁ on the basis of a timing when information regarding the commodity information symbol is received from the commodity detection unit 110. The association unit 130 determines whether or not a second symbol has been detected by either the commodity detection unit 110 or the service detection unit 120 (S202).

As described in the first exemplary embodiment, an operator performing a commodity checkout operation in a store generally performs an operation of reading a commodity information symbol or a service information symbol for each commodity. For this reason, there is a high possibility of commodity information symbols or service information symbols being sequentially detected for each commodity. That is, the next commodity is set as an object to be processed at a point in time when the next commodity information symbol is detected, and thus it is possible to infer that a service information symbol is not attached to a commodity having the previous commodity information symbol attached thereto. Accordingly, in a case where after a certain commodity information symbol is detected, a service information symbol is not detected and the next commodity information symbol is detected, there is a high possibility that there is no service information symbol corresponding to the commodity information symbol which is previously detected (that is, a first symbol). Consequently, in a case where a commodity information symbol is detected as a second symbol (S202: commodity information symbol), the association unit 130 determines that there is no service information to be associated with commodity information obtained from the commodity information symbol which is a first symbol (S203). The association unit 130 updates the association storage unit 132 on the basis of the determination in S203 and commodity information obtained from the second symbol detected in S202 (S204). Specifically, the same process, described in the first exemplary embodiment, as that in the example of FIG. 9 is performed.

In addition, regarding commodity information obtained from a commodity information symbol which is a second symbol, there is the possibility that a service information symbol is detected later and then an association process is performed. For this reason, the association unit 130 sets the commodity information symbol which is a second symbol as a new first symbol (S205) to proceed to the process in S202 and repeat the above-described process.

In addition, in a case where a service information symbol is detected as a second symbol (S202: service information symbol), the association unit 130 determines whether or not the second symbol has been acquired within a first threshold time Tₜₕ₁. In detail, the association unit 130 acquires a detection time T₂ of the second symbol (S206), and determines whether a difference between the detection time T₂ of the second symbol and the detection time T₁ of the first symbol is equal to or less than the first threshold time Tₜₕ₁ which is set in advance (S207).

In a case where the difference between the detection time T₂ of the second symbol and the detection time T₁ of the first symbol is equal to or less than the first threshold time Tₜₕ₁ which is set in advance (S207: YES), the association unit 130 performs a process of associating commodity information and service information, which are obtained from the respective symbols, with each other (S208). Specifically, the association unit 130 associates the commodity information obtained from the commodity information symbol which is a first symbol and the service information obtained from the service information symbol which is a second symbol with each other. The association unit 130 updates the association storage unit 132 on the basis of results of the association process in S208 (S209). Specifically, the same process, described in the first exemplary embodiment, as in the example of FIG. 10 is performed.

In a case where a process of associating commodity information and service information with each other is performed in S208, a symbol to be detected next is set as a first symbol. For this reason, in a case where the process of associating commodity information and service information with each other is performed in S208, the process returns to S101 of FIG. 5. Meanwhile, a flow of the series of processes is repeated until a commodity checkout operation for a certain customer is completed.

On the other hand, in a case where the difference between the detection time T₂ of the second symbol and the detection time T₁ of the first symbol exceeds the first threshold time Tₜₕ₁ which is set in advance (S207: NO), the association unit 130 performs the same process as that in S203. That is, the association unit 130 determines that there is no service information to be associated with commodity information obtained from the commodity information symbol which is a first symbol (S210). The association unit 130 updates the association storage unit 132 on the basis of the determination in S210 (S211). Specifically, the same process, described in the first exemplary embodiment, as that in the example of FIG. 11 is performed.

In addition, regarding service information obtained from a service information symbol which is a second symbol, there is the possibility a commodity information symbol is detected later and then an association process is performed. For this reason, the association unit 130 sets the commodity information symbol which is a second symbol as a new first symbol (S212). In this case, the service information symbol is set as a first symbol, and thus the process transitions to B.

<Process B>

The association unit 130 acquires a detection time T₁ of a first symbol in accordance with the detection of the first symbol (service information symbol) (S213). The association unit 130 further acquires the detection time T₁ of the service information symbol from, for example, the service detection unit 120. The invention is not limited thereto, and the association unit 130 may also determine the detection time T₁ on the basis of a timing when information regarding the service information symbol is received from the service detection unit 120. The association unit 130 determines whether or not a second symbol has been detected by either the commodity detection unit 110 or the service detection unit 120 (S214). These processes are the same as those in a case of the above-described process A.

In addition, in a case where a commodity information symbol is detected as a second symbol (S214: commodity information symbol), the association unit 130 determines whether or not the second symbol has been acquired within a second threshold time Tₜₕ₂. In detail, the association unit 130 acquires a detection time T₂ of the second symbol (S215), and determines whether a difference between the detection time T₂ of the second symbol and the detection time T₁ of the first symbol is equal to or less than the second threshold time Tₜₕ₂ which is set in advance (S216).

In a case where the difference between the detection time T₂ of the second symbol and the detection time T₁ of the first symbol is equal to or less than the second threshold time Tₜₕ₂ which is set in advance (S216: YES), the association unit 130 performs a process of associating commodity information and service information, which are obtained from the respective symbols, with each other (S217). Specifically, the association unit 130 associates service information obtained from the service information symbol which is a first symbol and commodity information obtained from the commodity information symbol which is a second symbol with each other. The association unit 130 updates the association storage unit 132 on the basis of results of the association process in S217 (S218). Specifically, the same process, described in the first exemplary embodiment, as that in the example of FIG. 13 is performed.

In a case where a process of associating commodity information and service information with each other is performed in S217, a symbol to be detected next is set as a first symbol. For this reason, in a case where a process of associating commodity information and service information with each other is performed in S217, the process returns to S101 of FIG. 5. Meanwhile, a flow of the series of processes is repeated until a commodity checkout operation for a certain customer is completed.

On the other hand, in a case where the difference between the detection time T₂ of the second symbol and the detection time T₁ of the first symbol exceeds the second threshold time Tₜₕ₂ which is set in advance (S216: NO), it is considered that there is a high possibility that detection omission (error) of a commodity information symbol occurs, similar to the first exemplary embodiment. Consequently, in this case, the association unit 130 determines that an error has occurred, and gives an instruction for performing error processing to an error processing unit (not shown) of the information processing device 10 (S219). The error processing performed in S219 is a process of notifying an operator of detection omission of a commodity information symbol using, for example, a message, a warning sound, or the like as described in the first exemplary embodiment and making the operator read the commodity information symbol. Meanwhile, the error processing is not limited to this example.

In addition, as described in the first exemplary embodiment, a commodity information symbol and a service information symbol are sequentially detected for each commodity. Further, with respect to service information, a commodity which is a target of a service is necessarily present. For this reason, the next commodity is set as an object to be processed at a point in time when the next service information symbol is detected, and thus it can be determined that a commodity information symbol regarding a commodity having the former service information symbol attached thereto has not been detected. Consequently, even when a service information symbol is detected as a second symbol (S214: service information symbol), the association unit 130 determines that detection omission (error) of a commodity information symbol has occurred in this case. The association unit 130 gives an instruction for performing error processing to an error processing unit (not shown) of the information processing device 10 (S219).

As described above, it is also possible to obtain the same effects as those in the first exemplary embodiment by the present exemplary embodiment.

Hereinafter, the above-described exemplary embodiments will be described in more detail with reference to a plurality of examples. The invention is not restricted by the following examples.

### Example 1

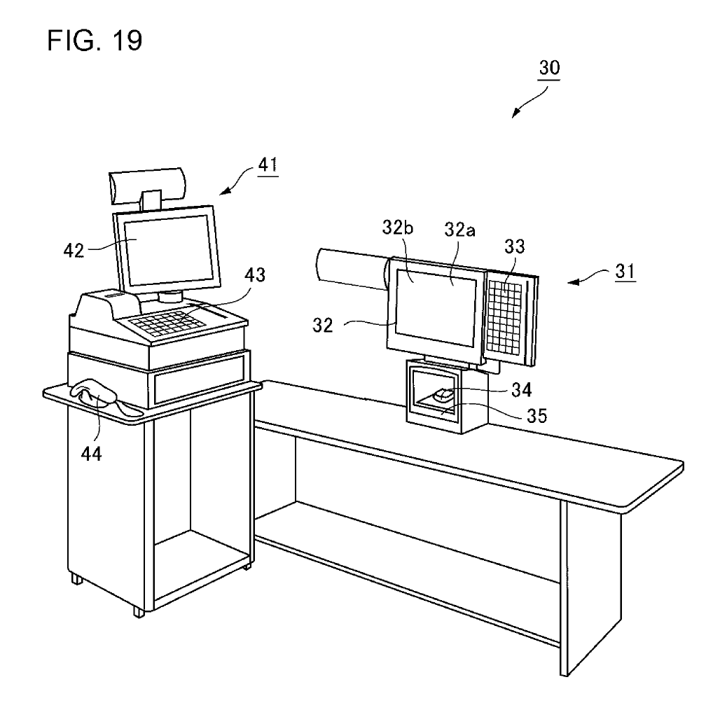

FIG. 19 is a diagram showing an example of a configuration of a POS register device. As shown in FIG. 19, Example 1 shows an example in which the information processing device 10 and the information processing method which are described above are applied to a point of sale (POS) register device 30. The POS register device 30 in Example 1 includes a checker device 31 and a cashier device 41. The checker device 31 registers a commodity as an object to be checked out, and transmits information regarding the commodity to be checked out to the cashier device 41. The cashier device 41 performs a settlement process of a commodity to be checked out. The object to be checked out can also be registered by both the checker device 31 and the cashier device 41.

The checker device 31 and the cashier device 41 in Example 1 includes a CPU 101, a memory 102, an input and output I/F 103, a communication unit 104, and the like, similar to FIG. 4. The information processing device 10 mentioned above can also be applied to any of the checker device 31 and the cashier device 41, and the above-described information processing method can also be performed by any of the checker device 31 and the cashier device 41.

The display unit 106 mentioned above is equivalent to at least one of a display unit 32a of a touch panel unit 32 and a display unit 42. The input unit 107 mentioned above is equivalent to at least one among a touch panel 32b of the touch panel unit 32, a keyboard 33, and a keyboard 43. The reading unit 108 mentioned above is equivalent to a scanner device 34 and a scanner device 44. The scanner device 34 captures a commodity image in which the appearance of a commodity held over a reading window 35 is seen. A commodity information symbol or a service information symbol is detected by processing an image captured by the scanner device 34, and thus it is possible to acquire commodity information or service information. The scanner device 44 may include a light source (not shown) and detect reflected light of light emitted to a packing material of a commodity, or the like by using a light receiving element (not shown), to thereby read commodity information or service information.

According to Example 1, association of commodity information and service information is managed as shown in, for example, FIGS. 8(a) to 15(a) in accordance with a detection timing of each symbol by the scanner device 34 or the scanner device 44. Specifically, in a case where a service information symbol is detected within a first predetermined reference time period after a commodity information symbol is detected, commodity information and service information, which are obtained using respective symbols, are associated with each other. In addition, even when a commodity information symbol is detected within a second predetermined reference time period longer than the first predetermined reference time period after a service information symbol is detected by the scanner device 34 or the scanner device 44, commodity information and service information, which are obtained using respective symbols, are associated with each other. Thereby, according to the present exemplary embodiment, it is possible to correctly associate commodity information and service information with each other. In addition, the screens as shown in FIGS. 8(b) to 15(b) are displayed on the touch panel unit 32 or the display unit 42 by the display processing unit 150 on the basis of the commodity information and the service information which are associated with each other in this manner. An operator of the POS register device 30 can easily ascertain whether or not commodity information and service information are correctly associated with each other on the basis of the screen displayed on the touch panel unit 32 or the display unit 42.

In Example 1, as shown in FIG. 7, the POS register device 30 includes the checker device 31 and the cashier device 41, but the POS register device 30 may be constituted by only the cashier device 41. In this case, the cashier device 41 may include the scanner device 34.

### Example 2

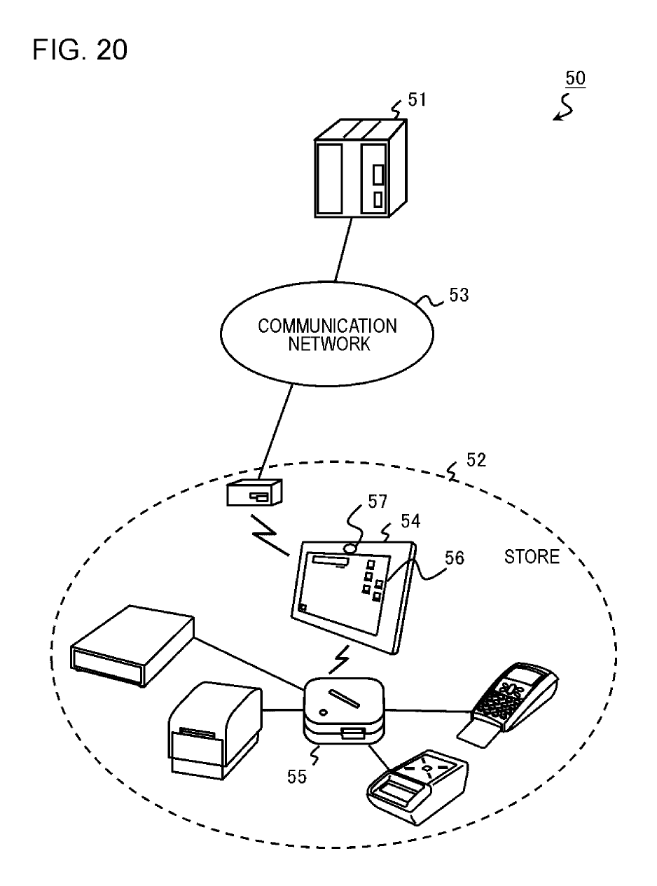

FIG. 20 is a diagram showing an example of a configuration of a POS system. As shown in FIG. 20, Example 2 shows an example in which the information processing device 10 and the method of presenting a commodity image which are described above are applied to a POS system 50. The POS system 50 in Example 2 includes a server device 51 and a store side configuration 52, and the server device 51 and the store side configuration 52 are communicably connected to each other by a communication network 53. The store side configuration 52 includes a store terminal 54, a stand 55, and the like which are capable of being connected to the communication network 53 through a communication relay device. The stand 55 is an apparatus for communicably connecting the store terminal 54 and another apparatus (a handy scanner, a cash drawer, a receipt printer, or the like).

The store terminal 54 is a general-purpose computer such as a personal computer (PC), a notebook PC, a tablet type terminal, or a smart phone, and transmits and receives data to and from the server device 51 to thereby realize the same function as that of the POS register device 30 mentioned above. The store terminal 54 includes a touch panel unit 56, an imaging unit 57, and the like. The display unit 106 mentioned above is equivalent to a display unit of the touch panel unit 56. The input unit 107 mentioned above is equivalent to a touch panel of the touch panel unit 56. The reading unit 108 mentioned above is equivalent to the imaging unit 57.

The server device 51 is a general server computer, and is configured as a WEB server, an application server, or the like. The store terminal 54 and the server device 51 include a CPU 101, a memory 102, an input and output I/F 103, a communication unit 104, and the like, similar to FIG. 4.

The information processing device 10 mentioned above may be configured as only the server device 51, only the store terminal 54, or both of them. Similarly, the above-described information processing method can be performed by only the server device 51, only the store terminal 54, or both of them. For example, in a case where a WEB system is used as an interface between the server device 51 and the store terminal 54, the above-described processing units are realized by the server device 51, and the store terminal 54 may operate as a simple display unit. On the contrary, all of the processing units may be realized in the store terminal 54. In addition, some of the processing units may be realized by the server device 51, and the remaining processing units may be realized by the store terminal 54. For example, the association unit 130 may be realized by the server device 51, and the other processing units may be realized by the store terminal 54.

According to Example 2, an operator of the store terminal 54 manages association of commodity information and service information as shown in, for example, FIGS. 8(a) to 15(a) in accordance with a detection timing of each symbol by a scanner device connected to the imaging unit 57 or the stand 55. Specifically, in a case where a service information symbol is detected within a first predetermined reference time period after a commodity information symbol is detected, commodity information and service information, which are obtained using the respective symbols, are associated with each other. In addition, even when a commodity information symbol is detected within a second predetermined reference time period longer than the first predetermined reference time period after a service information symbol is detected by the scanner device 34 or the scanner device 44, commodity information and service information, which are obtained using the respective symbols, are associated with each other. Thereby, according to the present exemplary embodiment, it is possible to correctly associate the commodity information and the service information with each other. In addition, the screens as shown in FIGS. 8(b) to 15(b) are displayed on the touch panel unit 56 by the display processing unit 150 on the basis of the information managed in this manner. An operator of the store terminal 54 can easily ascertain whether or not commodity information and service information are correctly associated with each other, on the basis of the screen displayed on the touch panel unit 56 in this manner.

### Example 3

The information processing device 10 and the information processing method which are described above can be applied not only to the POS register device and the POS system 50 but also to all devices assisting the determination of a commodity. For example, the information processing device 10 and the information processing method which are described above may be applied to a general-purpose computer, such as a PC or a smart device, which is used by general users.

In this manner, the invention does not exclude the information processing device being realized by a plurality of devices (a housing including a plurality of computers or a plurality of CPUs). In addition, the above-described exemplary embodiments may be combined with each other within a range in which the contents thereof do not conflict with each other.

Although the exemplary embodiments and examples of the invention have been described above with reference to the accompanying drawings, these are merely illustrative of the invention, and various other configurations may also be adopted.

For example, in the first exemplary embodiment, a description has been given of an example in which commodity information and service information are displayed on the display unit 106 at a point in time when a correspondence relationship therebetween is fixed. However, the invention is not limited thereto, and commodity information and service information which are obtained from respective symbols may be displayed at a timing when the symbols are detected by the commodity detection unit 110 and the service detection unit 120. In this case, display contents of the display unit 106 are updated in accordance with results of an association process of the association unit 130 based on the elapse of a first predetermined reference time period or a second predetermined reference time period, the order of detection of symbols, or the like.

In addition, for example, in the second exemplary embodiment, the association unit 130 may calculate an elapsed time on the basis of a detection time T₁ of a first symbol and the present time. In this case, an association process is performed on another symbol detected when the calculated elapsed time is equal to or less than a first threshold time Tₜₕ₁ or a second threshold time Tₜₕ₂.

In addition, for example, after a commodity information symbol of a commodity having the service information symbol is detected and before a first predetermined reference time period elapses, a service information symbol may not be detected due to a reason such as the first predetermined reference time period being short with respect to a processing speed of one commodity of an operator. In addition, after a commodity information symbol of a commodity having no service information symbol is detected and before the first predetermined reference time period elapses, a service information symbol related to a different commodity may also be detected due to a reason such as the first predetermined reference time period being long with respect to a processing speed of one commodity of an operator. In these cases, an erroneous association process may be performed by the association unit 130. Consequently, the information processing device 10 may further include an association correction unit (not shown) that corrects the erroneous association which is performed by the association unit 130 in this manner. The association correction unit receives, for example, an operation of selecting association to be corrected and an operation of performing change to a correct association through the display unit 106, the input unit 107, or the like, and corrects the association on the basis of the received operations. Further, the information processing device 10 may further include a first adjusting unit (not shown) that adjusts the first predetermined reference time period in accordance with the correction of association by the association correction unit. The first adjusting unit calculates an optimal first predetermined reference time period by statistically using, for example, detection intervals when symbols are detected in the order of a commodity information symbol and a service information symbol which are obtained from an operator's actual process. The first adjusting unit calculates, for example, an average value, an intermediate value, and the like of detection intervals which are obtained for respective operators to thereby obtain an optimal first predetermined reference time period for each operator. In addition, the first adjusting unit may obtain a first predetermined reference time period common to a plurality of operators by using an average value, an intermediate value, and the like of first predetermined reference time periods for respective operators. Thereby, in a case where erroneous association occurs due to a long first predetermined reference time period and is corrected, the first predetermined reference time period is adjusted to a short time on the basis of an operator's actual process. In addition, in a case where erroneous association occurs due to a short first predetermined reference time period and is corrected, the first predetermined reference time period is adjusted to a long time on the basis of an operator's actual process. That is, the first predetermined reference time period is optimized in accordance with an operator's processing speed. As a result, it is possible to expect an effect of reducing the probability of occurrence of erroneous association.

In addition, in a case where after a service information symbol is detected by the service detection unit 120, a commodity information symbol is not detected in spite of the same object (commodity) being detected by the commodity detection unit 110, there is a possibility that an operator requires time for a commodity information symbol to be detected. Consequently, the information processing device 10 may further include a second adjusting unit (not shown) that adjusts a second predetermined reference time period in a case where the commodity detection unit 110 detects the same object (commodity) at and after the detection of a service information symbol. In this case, the commodity detection unit 110 is configured to be capable of further detecting any object from an image by using, for example, a known image recognition algorithm or the like. In addition, the commodity detection unit 110 may determine whether or not the same object has been detected by using, for example, an algorithm of tracking the same object between a plurality of images, or the like. In addition, the second adjusting unit adjusts a second predetermined reference time period, for example, by increasing the second predetermined reference time period, temporarily stopping a timer for managing the elapse of the second predetermined reference time period, or the like. In this manner, it is possible to avoid the omission of association in the above-described case, as compared to a case where it is simply determined whether to perform association from the elapse of a time which is set in advance. As a result, it is possible to expect an effect of improving the accuracy of an association process.

In addition, in the plurality of flow charts used in the above description, a plurality of steps (processes) are described in order. However, the order of execution of the processes performed in the exemplary embodiments is not limited to the described order. In the exemplary embodiments, the order of the steps shown in the drawings can be changed within a range in which any trouble does not occur in terms of contents.

Hereinafter, an example of a reference configuration will be appended.

1. An information processing device including:

a commodity detection unit that detects a commodity information symbol;

a service detection unit that detects a service information symbol; and

an association unit that: associates with each other commodity information and service information, which are obtained using the detected commodity information symbol and service information symbol in a case where after the commodity information symbol is detected and before a first predetermined time period elapses, the service information symbol is detected; or associates with each other commodity information and service information, which are obtained using the detected commodity information symbol and service information symbol in a case where after the service information symbol is detected and before a second predetermined time period longer than the first predetermined time period elapses, the commodity information symbol is detected.

2. The information processing device according to 1,

wherein the association unit uses the first predetermined time period and the second predetermined time period which are stored, or uses the first predetermined time period and the second predetermined time period which are obtained by addition or subtraction with respect to a stored reference time period.

3. The information processing device according to 1 or 2, further including:

an association correction unit that receives an operation of correcting an association which is already made by the association unit to thereby correct the association in accordance with the operation; and

a first adjusting unit that adjusts the first predetermined time period in accordance with the correction of the association by the association correction unit.

4. The information processing device according to any one of 1 to 3,

wherein the commodity detection unit further detects an object from an image, and

wherein the information processing device further includes a second adjusting unit that extends the second predetermined time period in a case where the same object is detected by the commodity detection unit at and after the detection of the service information symbol.

5. The information processing device according to any one of 1 to 4, further including:

an output unit that performs a predetermined output in a case where after the service information symbol is detected and before the second predetermined time period elapses, the commodity information symbol is not detected and a next service information symbol is detected.

6. An information processing device including:

a first detection unit that detects a first sign from an image;

a second detection unit that detects a second sign from an image; and

an output unit that outputs commodity information obtained using the first sign and service information obtained using the second sign in association with each other in a case where after the first sign is detected and before a first predetermined time period elapses, the second sign is detected, or outputs commodity information obtained using the first sign and service information obtained using the second sign in association with each other in a case where after the second sign is detected and before a second predetermined time period longer than the first predetermined time period elapses, the first sign is detected.

7. An information processing method which is performed by at least one computer, the method including:

detecting a commodity information symbol;

detecting a service information symbol; and

associating with each other commodity information and service information, which are obtained using the detected commodity information symbol and service information symbol in a case where after the commodity information symbol is detected and before a first predetermined time period elapses, the service information symbol is detected, or associating with each other commodity information and service information, which are obtained using the detected commodity information symbol and service information symbol in a case where after the service information symbol is detected and before a second predetermined time period longer than the first predetermined time period elapses, the commodity information symbol is detected.

8. The information processing method according to 7,

wherein the computer uses the first predetermined time period and the second predetermined time period which are stored in a storage unit, or uses the first predetermined time period and the second predetermined time period which are obtained by addition or subtraction with respect to a reference time period which is stored in the storage unit.

9. The information processing method according to 7 or 8, further including:

receiving an operation of correcting an association which is already made to thereby correct the association in accordance with the operation; and

adjusting the first predetermined time period in accordance with the correction of the association.

10. The information processing method according to any one of 7 to 9, further including:

further detecting an object from an image; and

adjusting the second predetermined time period in a case where the same object is detected at and after the detection of the service information symbol.

11. The information processing method according to any one of 7 to 10, further including:

performing a predetermined output in a case where after the service information symbol is detected and before the second predetermined time period elapses, the commodity information symbol is not detected and a next service information symbol is detected.

12. A program causing at least one computer to perform the information processing method according to any one of 7 to 11.

The application is based on Japanese Patent Application No. 2014-136164 filed on Jul. 1, 2014, the content of which is incorporated herein by reference.

What is claimed is:

1. An information processing device comprising:
a commodity detection unit that detects a commodity information symbol;
a service detection unit that detects a service information symbol; and
an association unit that: associates with each other commodity information and service information, which are obtained using the detected commodity information symbol and service information symbol in a case where after the commodity information symbol is detected and before a first predetermined time period elapses, the service information symbol is detected; or associates with each other commodity information and service information, which are obtained using the detected commodity information symbol and service information symbol in a case where after the service information symbol is detected and before a second predetermined time period longer than the first predetermined time period elapses, the commodity information symbol is detected.

2. The information processing device according to claim 1,
wherein the association unit uses the first predetermined time period and the second predetermined time period which are stored, or uses the first predetermined time period and the second predetermined time period which are obtained by addition or subtraction with respect to a stored reference time period.

3. The information processing device according to claim 1, further comprising:
an association correction unit that receives an operation of correcting an association which is already made by the association unit to thereby correct the association in accordance with the operation; and
a first adjusting unit that adjusts the first predetermined time period in accordance with the correction of the association by the association correction unit.

4. The information processing device according to claim 1,
wherein the commodity detection unit further detects an object from an image, and
wherein the information processing device further includes a second adjusting unit that extends the second predetermined time period in a case where the same object is detected by the commodity detection unit at and after the detection of the service information symbol.

5. The information processing device according to claim 1, further comprising:
an output unit that performs a predetermined output in a case where after the service information symbol is detected and before the second predetermined time period elapses, the commodity information symbol is not detected and a next service information symbol is detected.

6. An information processing method which is performed by at least one computer, the method comprising:
detecting a commodity information symbol;
detecting a service information symbol; and
associating with each other commodity information and service information, which are obtained using the detected commodity information symbol and service information symbol in a case where after the commodity information symbol is detected and before a first predetermined time period elapses, the service information symbol is detected, or associating with each other commodity information and service information, which are obtained using the detected commodity information symbol and service information symbol in a case where after the service information symbol is detected and before a second predetermined time period longer than the first predetermined time period elapses, the commodity information symbol is detected.

7. A non-transitory computer readable medium storing a program causing at least one computer to perform an information processing method, the information processing method comprising:
detecting a commodity information symbol;
detecting a service information symbol; and
associating with each other commodity information and service information, which are obtained using the detected commodity information symbol and service information symbol in a case where after the commodity information symbol is detected and before a first predetermined time period elapses, the service information symbol is detected, or associating with each other commodity information and service information, which are obtained using the detected commodity information symbol and service information symbol in a case where after the service information symbol is detected and before a second predetermined time period longer than the first predetermined time period elapses, the commodity information symbol is detected.
